(19) United States
(12) Patent Application Publication
(10) Pub. No.: US 2026/0122682 A1
(43) Pub. Date: Apr. 30, 2026

(54) METHOD AND APPARATUS FOR MANAGING TXOP CONSIDERING DPS MODE IN WIRELESS LOCAL AREA NETWORK SYSTEM

(71) Applicant: Samsung Electronics Co., Ltd., Suwon-si (KR)

(72) Inventors: Taeyoung HA, Suwon-si (KR); Seongho BYEON, Suwon-si (KR); Suhwook KIM, Suwon-si (KR); Jonghoe KOO, Suwon-si (KR)

(21) Appl. No.: 19/375,751

(22) Filed: Oct. 31, 2025

(30) Foreign Application Priority Data
Oct. 31, 2024 (KR) 10-2024-0152708

(51) Int. Cl. H04W 74/0816; H04W 28/02; H04W 52/02; H04W 84/12

(52) U.S. Cl. CPC H04W 74/0816; H04W 28/0278; H04W 52/0206; H04W 84/12

(57) ABSTRACT

The disclosure relates to an improved wireless local area network (LAN) system. A method and device for transmission opportunity (TXOP) sharing that considers dynamic power save (DPS) in an improved wireless LAN system are provided. Specifically, the disclosure provides a method performed by a first access point (AP) in a wireless LAN system, the method including transmitting, to a second AP, a first frame for notifying of sharing of a transmission opportunity (TXOP), receiving, from the second AP, a second frame for responding to the first frame, the second frame including information on a dynamic power save (DPS) mode related to the TXOP and information on a required TXOP length, and transmitting, to the second AP, a third frame including information on a TXOP to be shared with the second AP.

### CROSS-REFERENCE TO RELATED APPLICATIONS

This application is based on and claims priority under 35 U.S.C. § 119(a) of a Korean patent application number 10-2024-0152708, filed on October 31, 2024, in the Korean Intellectual Property Office, the disclosure of which is incorporated by reference herein in its entirety.

### BACKGROUND

### 1. Field

The disclosure relates to a wireless local area network (WLAN) system. More particularly, the disclosure relates to a method and device for managing transmission opportunity (TXOP) in a WLAN system by considering dynamic power save (DPS) mode.

### 2. Description of Related Art

Wireless local area network (WLAN) is a technology that allows users to access the internet through mobile devices or laptops within a certain distance from the location where an access point (AP) is installed. WLAN systems are evolving to meet various objectives, including improved transmission rates, increased bandwidth, enhanced reliability, reduced errors, and decreased latency. The Institute of Electrical and Electronics Engineers (IEEE) publishes 802.11 standard specifications for WLAN systems, and the wireless-fidelity (Wi-Fi) Alliance refers to technologies based on the 802.11 standard specifications as WiFi (or Wi-Fi, Wireless Fidelity).

Wi-Fi technology has evolved through several generations of 802.11 standards. For example, the 802.11ac standard document addresses improvements for very high throughput (VHT), the 802.11ax standard document addresses improvements for high efficiency (HE), and the 802.11be standard document addresses improvements for extreme high throughput (EHT).

Meanwhile, with the popularization of terminals, wireless LANs, which have potential as open wireless networks, are rapidly expanding, and Wi-Fi is being used to provide high-speed data services throughout cities, including schools, airports, hotels, and offices. In addition, technologies for providing an improved wireless communication environment in wireless LAN systems are being discussed, and various technologies are being proposed and researched in response to demands for further improving the reliability of wireless LAN systems.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for managing and controlling transmission opportunity (TXOP) considering dynamic power save (DPS) in a wireless LAN system.

Another aspect of the disclosure is to provide a method and device for effectively performing transmission opportunity (TXOP) sharing, that is TXOP sharing (TXS), in a coordinated time division multiple access (C-TDMA) environment.

Another aspect of the disclosure is to provide a method and device for efficiently performing TXS by considering the DPS of an access point (AP) when performing the TXS.

Another aspect of the disclosure is to provide a procedure and frame structure for performing C-TDMA (or TXS) considering DPS according to an embodiment of the disclosure.

Additional aspects will be set forth in part in the description which follows and, in part, will be apparent from the description, or may be learned by practice of the presented embodiments.

In accordance with an aspect of the disclosure, a method performed by a first access point (AP) in a wireless local area network (LAN) system is provided. The method includes transmitting, to a second AP, a first frame for notifying of sharing of a transmission opportunity (TXOP), receiving, from the second AP, a second frame for responding to the first frame, the second frame including information on a dynamic power save (DPS) mode related to the TXOP and information on a required TXOP length, and transmitting, to the second AP, a third frame including information on a TXOP to be shared with the second AP.

In accordance with another aspect of the disclosure, a method performed by a second access point (AP) in a wireless local area network (LAN) system is provided. The method includes receiving, from a first AP, a first frame for notifying of sharing of a transmission opportunity (TXOP), transmitting, to the first AP, a second frame for responding to the first frame, the second frame including information on a dynamic power save (DPS) mode related to the TXOP and information on a requested TXOP length, and receiving, from the first AP, a third frame including information on a TXOP to be shared with the second AP.

In accordance with another aspect of the disclosure, a first access point (AP) in a wireless local area network (LAN) system is provided. The first AP in a wireless LAN system includes a transceiver, memory, including one or more storage media, storing instructions, and one or more processors communicatively coupled to the transceiver and the memory, wherein the instructions, when executed by the one or more processors individually or collectively, cause the first AP to, transmit, to a second AP, a first frame for notifying of sharing of a transmission opportunity (TXOP), receive, from the second AP, a second frame for responding to the first frame, the second frame including information on a dynamic power save (DPS) mode related to the TXOP and information on a requested TXOP length, and transmit, to the second AP, a third frame including information on a TXOP to be shared with the second AP.

In accordance with another aspect of the disclosure, a second access point (AP) in a wireless local area network (LAN) system is provided. The second AP in a wireless LAN system includes a transceiver, memory, including one or more storage media, storing instructions, and one or more processors communicatively coupled to the transceiver and the memory, wherein the instructions, when executed by the one or more processors individually or collectively, cause the second AP to receive, from a first AP, a first frame for notifying of sharing of a transmission opportunity (TXOP), transmit, to the first AP, a second frame for responding to the first frame, the second frame including information on a dynamic power save (DPS) mode related to the TXOP and information on a requested TXOP length, and receive, from the first AP, a third frame including information on a TXOP to be shared with the second AP.

According to various embodiments of the disclosure, TXOP is effectively controlled and managed based on dynamic power save (DPS) mode in a wireless LAN system where coordinated time division multiple access (C-TDMA) is applied. In addition, signaling overhead is reduced and the efficiency of wireless resource utilization may be increased through the improvement of the signaling procedure and frame structure to perform the above-described TXOP control and management.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates the configuration of a device for wireless communication according to an embodiment of the disclosure;

FIG. 2 illustrates n structure of a wireless LAN system according to an embodiment of the disclosure;

FIG. 3 illustrates a link setup process according to an embodiment of the disclosure;

FIG. 4 illustrates a backoff operation according to an embodiment of the disclosure;

FIG. 5 illustrates a carrier sense multiple access with collision avoidance (CSMA/CA)-based frame transmission according to an embodiment of the disclosure;

FIG. 6 illustrates a format of a frame used in a wireless LAN system according to an embodiment of the disclosure;

FIG. 7 illustrates a format of a physical layer protocol data unit (PPDU) of a wireless LAN system according to an embodiment of the disclosure;

FIG. 8 illustrates another format of a PPDU of a wireless LAN system according to an embodiment of the disclosure;

FIG. 9 is a diagram illustrating operations of coordinated time division multiple access (C-TDMA) in a wireless LAN system according to an embodiment of the disclosure;

FIG. 10 is a diagram illustrating a C-TDMA (or TXS) operation according to an embodiment of the disclosure;

FIG. 11 is a diagram illustrating a frame format structure according to an embodiment of the disclosure;

FIG. 12 is a diagram illustrating a frame format structure according to an embodiment of the disclosure;

FIG. 13 is a diagram illustrating a frame format structure according to an embodiment of the disclosure;

FIG. 14 is a diagram illustrating a frame format structure according to an embodiment of the disclosure;

FIG. 15 is a diagram illustrating a C-TDMA (or TXS) operation considering DPS according to an embodiment of the disclosure;

FIG. 16 is a diagram illustrating a C-TDMA (or TXS) operation considering DPS according to an embodiment of the disclosure;

FIG. 17 is a diagram illustrating a C-TDMA (or TXS) operation considering DPS according to an embodiment of the disclosure;

FIG. 18 is a diagram illustrating a C-TDMA (or TXS) operation considering DPS according to an embodiment of the disclosure;

FIG. 19 illustrates a flowchart related to the operation of a first AP in a wireless LAN system according to an embodiment of the disclosure;

FIG. 20 illustrates a flowchart related to the operation of a first AP in a wireless LAN system according to an embodiment of the disclosure; and

FIG. 21 illustrates a flowchart related to the operation of a second AP in a wireless LAN system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are limited to the bibliographical meanings, but, are merely used by the inventors to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Herein, it will be understood that each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks(or functions) shown in succession may in fact be performed substantially concurrently or the blocks may sometimes be performed in the reverse order, depending upon the functionality involved.

As used in embodiments of the disclosure, a “~unit” may refer to a software element or a hardware element, such as a field programmable gate array (FPGA) or an application specific integrated circuit (ASIC), which performs a predetermined function. However, the term including the word “~unit” does not always have a meaning limited to software or hardware. The “~unit” may be constructed either to be stored in an addressable storage medium or to execute one or more processors. Therefore, the “~unit” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “~unit” may be either combined into a smaller number of components and a “~unit,” or divided into additional components and a “~unit.” Moreover, the components and “~units” may be implemented to reproduce one or more central processing units (CPUs) within a device or a security multimedia card. Further, in the embodiments, the “˜unit” may include one or more processors.

As used herein, in the case where an element is referred to as being "connected", "coupled", or "linked" to any other element, this may cover not only direct connections but also indirect connections in which another element may exist therebetween. As used herein, the expression “include” or “have” are intended to specify the existence of mentioned features, steps, operations, elements, and/or components, but does not preclude the existence or addition of one or more other features, steps, operations, elements, components, and/or combinations thereof.

As used herein, such terms as “a first” and “a second” are used only for the purpose of distinguishing between one element and any other element and not used to limit the elements, and unless mentioned specially, do not limit the order or the importance of the elements. Therefore, a first element in an embodiment may be termed a second element in another embodiment, and similarly, a second element in an embodiment may be termed a first element in another embodiment without departing from the scope of the disclosure.

The terms in the disclosure are used for the sake of describing particular embodiments and are not intended to limit the claims. As used in the description of embodiments and appended claims, a singular expression may include a plural expression unless they are definitely different in the context. As used herein, the term "and/or" may refer to one of relevant items enumerated or may refer to and include any or all possible combinations of one or more thereof. In addition, as used herein, the symbol "/" between words has the same meaning as the term "and/or" unless mentioned otherwise.

Examples of the disclosure may be applied to various wireless communication systems. For example, examples of the disclosure may be applied to a wireless LAN system. For example, examples of the disclosure may be applied to a wireless LAN system based on the IEEE 802.11a/g/n/ac/ax/be standard. In addition, examples of the disclosure may be applied to a wireless LAN system based on the newly discussed IEEE 802.11bn (or ultra-high reliability (UHR)) standard. In addition, examples of the disclosure may be applied to a wireless LAN system based on the next-generation standard after IEEE 802.11bn.

In addition, examples of the disclosure may also be applied to a cellular wireless communication system. For example, examples of the disclosure may be applied to a cellular wireless communication system based on Long-Term Evolution (LTE), LTE-Advanced (LTE-A), and New Radio (NR) technologies based on 3rd Generation Partnership Project (3GPP) standard.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

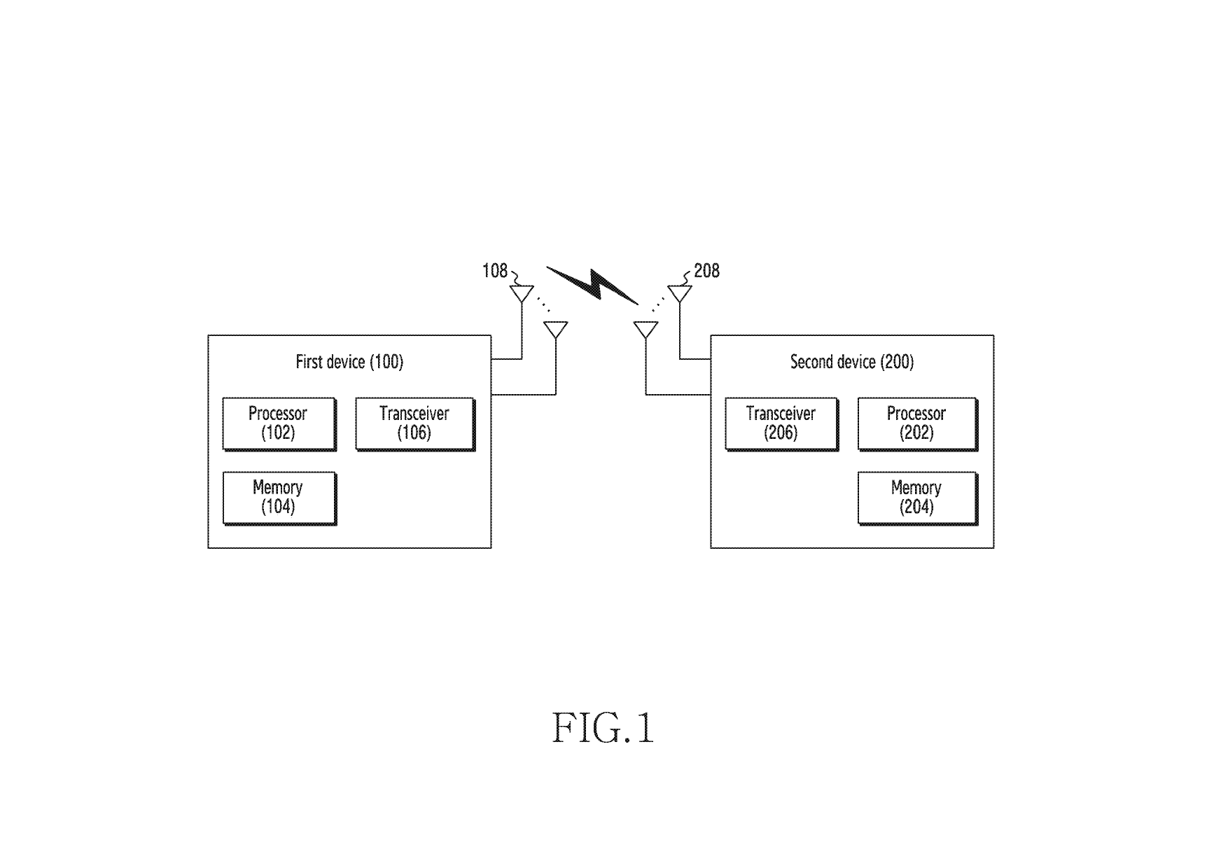

FIG. 1 illustrates the configuration of a device for wireless communication according to an embodiment of the disclosure.

A first device 100 and a second device 200FIG. 1 may be replaced with various terms such as a terminal, a wireless device, a wireless transmit and receive unit (WTRU), a user equipment (UE), a mobile station (MS), a user terminal (UT), a mobile subscriber station (MSS), a mobile subscriber unit (MSU), a subscriber station (SS), an advanced mobile station (AMS), a wireless terminal (WT), a client terminal, or simply a user.

In addition, the first device 100 and the second device 200 may be replaced with various terms such as an access point (AP), a base station (BS), a fixed station, a Node B, a base transceiver system (BTS), a network, an artificial intelligence (AI) system, a road side unit (RSU), a repeater, a router, a relay, a gateway, etc.

The devices 100 and 200 illustrated in FIG. 1 may also be referred to as stations (STAs). For example, the devices 100 and 200 illustrated in FIG. 1 may be referred to by various terms such as a transmitting device, a receiving device, a transmitting STA, a receiving STA, etc. For example, the STAs 100 and 200 may function as an access point (AP) or as a non-AP. That is, in the disclosure, the STAs 100 and 200 may perform the functions of an AP and/or a non-AP. If the STAs 100 and 200 perform an AP function, they may simply be referred to as APs, and if the STAs 100 and 200 perform a non-AP function, they may simply be referred to as STAs. In addition, in the disclosure, an AP may also be referred to as an AP STA.

Referring to FIG. 1, the first device 100 and the second device 200 may transmit and/or receive wireless signals through various wireless LAN technologies (e.g., technologies based on the IEEE 802.11 standard). The first device 100 and the second device 200 may include interfaces for a medium access control (MAC) layer and a physical (PHY) layer that comply with the specifications of the IEEE 802.11 standard.

In addition, the first device 100 and the second device 200 may additionally support various wireless communication technologies (e.g., technologies based on 3GPP LTE, LTE-A, or NR standard) other than wireless LAN technologies. In addition, the devices of the disclosure may be implemented as various devices such as mobile phones, vehicles, personal computers, augmented reality (AR) equipment, and virtual reality (VR) equipment. In addition, the devices of the disclosure may support various communication services such as voice calls, video calls, data communications, autonomous driving, machine-type communication (MTC), machine-to-machine (M2M), device-to-device (D2D), and the Internet of Things (IoT).

The first device 100 includes one or more processors 102 and one or more memories 104, and may further include one or more transceivers (or transmission/reception units) 106 and/or one or more antennas 108. The processor 102 controls the memory 104 and/or the transceiver 106, and may be configured to implement the descriptions, functions, procedures, suggestions, methods, and/or operational flowcharts disclosed in the disclosure. For example, the processor 102 may process information in the memory 104 to generate first information and/or a first signal, and then transmit a wireless signal including the first information and/or the first signal through the transceiver 106. In addition, the processor 102 may receive a wireless signal including second information and/or a second signal through the transceiver 106, and then store information acquired through signal processing of the second information and/or the second signal in the memory 104. The memory 104 may be connected to the processor 102 and may store various information related to the operation of the processor 102. For example, the memory 104 may store a software code including instructions for performing some or all of the processes controlled by the processor 102, or for performing the descriptions, functions, procedures, suggestions, methods, and/or operational flowcharts disclosed in the disclosure. The processor 102 and the memory 104 may be a portion of a communication modem/circuit/chip designed to implement wireless LAN technology (e.g., IEEE 802.11 document-based technology). The transceiver 106 may be connected to the processor 102 and may transmit and/or receive a wireless signal through one or more antennas 108. The transceiver 106 may include a transmitter and/or a receiver. The transceiver 106 may be used interchangeably with a radio frequency (RF) unit.

The second device 200 includes one or more processors 202 and one or more memories 204, and may further include one or more transceivers (or transmission/reception units) 206 and/or one or more antennas 208. The processor 202 controls the memory 204 and/or the transceiver 206, and may be configured to implement the descriptions, functions, procedures, suggestions, methods, and/or operational flowcharts disclosed in the disclosure. For example, the processor 202 may process information in the memory 204 to generate third information and/or a third signal, and then transmit a wireless signal including the third information and/or the third signal through the transceiver 206. In addition, the processor 202 may receive a wireless signal including fourth information and/or a fourth signal through the transceiver 206, and then store information acquired through signal processing of the fourth information and/or the fourth signal in the memory 204. The memory 204 may be connected to the processor 202 and may store various information related to the operation of the processor 202. For example, the memory 204 may store a software code including instructions for performing some or all of the processes controlled by the processor 202, or for performing the descriptions, functions, procedures, suggestions, methods, and/or operational flowcharts disclosed in the disclosure. The processor 202 and the memory 204 may be a portion of a communication modem/circuit/chip designed to implement wireless LAN technology (e.g., IEEE 802.11 document-based technology). The transceiver 206 may be connected to the processor 202 and may transmit and/or receive a wireless signal through one or more antennas 208. The transceiver 206 may include a transmitter and/or a receiver. The transceiver 206 may be used interchangeably with an RF unit.

Hereinafter, hardware elements of the devices 100 and 200 will be described in more detail. Although not limited to the following, operations of one or more protocol layers may be implemented by one or more processors 102 and 202. For example, one or more processors 102 and 202 may implement operations of one or more layers (e.g., functional layers such as PHY and MAC). The one or more processors 102 and 202 may generate one or more protocol data units (PDUs) and/or one or more service data units (SDUs) according to the descriptions, functions, procedures, suggestions, methods, and/or operational flowcharts disclosed in the disclosure. The one or more processors 102 and 202 may generate a message, control information, data, or information according to the descriptions, functions, procedures, suggestions, methods, and/or operational flowcharts disclosed in the disclosure. The one or more processors 102 and 202 may generate a signal (e.g., a baseband signal) including PDUs, SDUs, messages, control information, data, traffic, or information according to the functions, procedures, suggestions, and/or methods disclosed in the disclosure, and provide the signal to one or more transceivers 106 and 206. The one or more processors 102 and 202 may generate a signal (e.g., a baseband signal) from one or more transceivers 106 and 206, and acquire PDUs, SDUs, messages, control information, data, traffic, or information according to the descriptions, functions, procedures, suggestions, methods, and/or operational flowcharts disclosed in the disclosure.

One or more memories 104 and 204 may be connected to the one or more processors 102 and 202 and may store various types of data, signals, messages, information, programs, codes, indications, and/or instructions. The one or more memories 104 and 204 may be composed of read-only memory (ROM), random access memory (RAM), erasable programmable ROM (EPROM), flash memory, hard drives, registers, cache memory, computer-readable storage media, and/or combinations thereof. The one or more memories 104 and 204 may be located internally and/or externally to one or more processors 102 and 202. In addition, one or more memories 104 and 204 may be connected to one or more processors 102 and 202 through various technologies such as wired or wireless connections.

One or more transceivers 106 and 206 may transmit user data, control information, data, traffic, wireless signals, and/or channels mentioned in the methods and/or operational flowchart of the disclosure to one or more other devices. The one or more transceivers 106 and 206 may receive, from one or more other devices, user data, control information, data, traffic, radio signals, and/or channels mentioned in the descriptions, functions, procedures, suggestions, methods, and/or operational flowcharts disclosed in the disclosure. For example, the one or more transceivers 106 and 206 may be connected to the one or more processors 102 and 202 and may transmit and receive wireless signals. For example, one or more processors 102 and 202 may control one or more transceivers 106 and 206 to transmit user data, control information, traffic, radio signals, and/or channels to one or more other devices. In addition, one or more processors 102 and 202 may control one or more transceivers 106 and 206 to receive user data, control information, traffic, radio signals, and/or channels from one or more other devices. In addition, one or more transceivers 106 and 206 may be connected to one or more antennas 108 and 208, and one or more transceivers 106 and 206 may be configured to transmit and receive user data, control information, traffic, radio signals, and/or channels mentioned in the descriptions, functions, procedures, suggestions, methods, and/or operational flowcharts disclosed in the disclosure through one or more antennas 108 and 208. In the disclosure, one or more antennas 108 and 208 may be multiple physical antennas or multiple logical antennas (e.g., antenna ports). One or more transceivers 106 and 206 may convert the received radio signals/channels from RF band signals to baseband signals to process the received user data, control information, radio signals/channels, and the like by using one or more processors 102, 202. The one or more transceivers 106 and 206 may convert user data, control information, radio signals/channels, and the like processed by using the one or more processors 102 and 202 from a baseband signal to an RF band signal. To this end, one or more transceivers 106 and 206 may include an (analog) oscillator and/or a filter.

According to an example, one of the devices 100 and 200 may perform the intended operation of the AP, and the other of the devices 100 and 200 may perform the intended operation of the non-AP STA. According to another example, the transceiver 106 and 206 of FIG. 1 may perform signal transmission and/or reception of a signal (e.g., a packet or physical layer protocol data unit (PPDU) according to IEEE 802.11a/b/g/n/ac/ax/be/bn).

In addition, in the disclosure, an operation in which various STAs generate transmission/reception signals or perform data processing or calculation in advance for transmission/reception signals may be performed by the processors 102 and 202 of FIG. 1. For example, an example of the operation of generating transmission/reception signals or performing data processing or calculation in advance for transmission/reception signals may include 1) Determining/acquiring/configuring/calculating/decoding/encoding bit information in fields (e.g., signal (SIG), short training field (STF), long training field (LTF), Data, etc.) included in the PPDU, 2) Determining/configuring/acquiring time resource or frequency resource (e.g., subcarrier resource) used for fields (e.g., SIG, STF, LTF, Data, etc.) included in the PPDU, 3) Determining/configuring/acquiring specific sequences (e.g., pilot sequences, STF/LTF sequences, extra sequences applied to SIG) used for fields (e.g., SIG, STF, LTF, Data, etc.) included in the PPDU, 4) Power control and/or power saving operations applied to STAs, and 5) Determining/acquiring/configuring/calculating/decoding/encoding an acknowledgement (ACK) signal, etc. In addition, in the following example, various information (e.g., information related to fields/subfields/control fields/parameters/power, etc.) used by various STAs for determining/acquiring/configuring/calculating/decoding/encoding of transmission/reception signals may be stored in the memories 104 and 204 of FIG. 1.

Hereinafter, the downlink (DL) refers to the link for communication from an AP STA to a non-AP STA, and downlink PPDUs/packets/signals, etc. may be transmitted and received through the downlink. In downlink communication, the transmitter may be a portion of an AP STA, and the receiver may be a portion of a non-AP STA. The uplink (UL) refers to the link for communication from a non-AP STA to an AP STA, and uplink PPDUs/packets/signals, etc. may be transmitted and received through the uplink. In uplink communication, the transmitter may be a portion of a non-AP STA, and the receiver may be a portion of an AP STA.

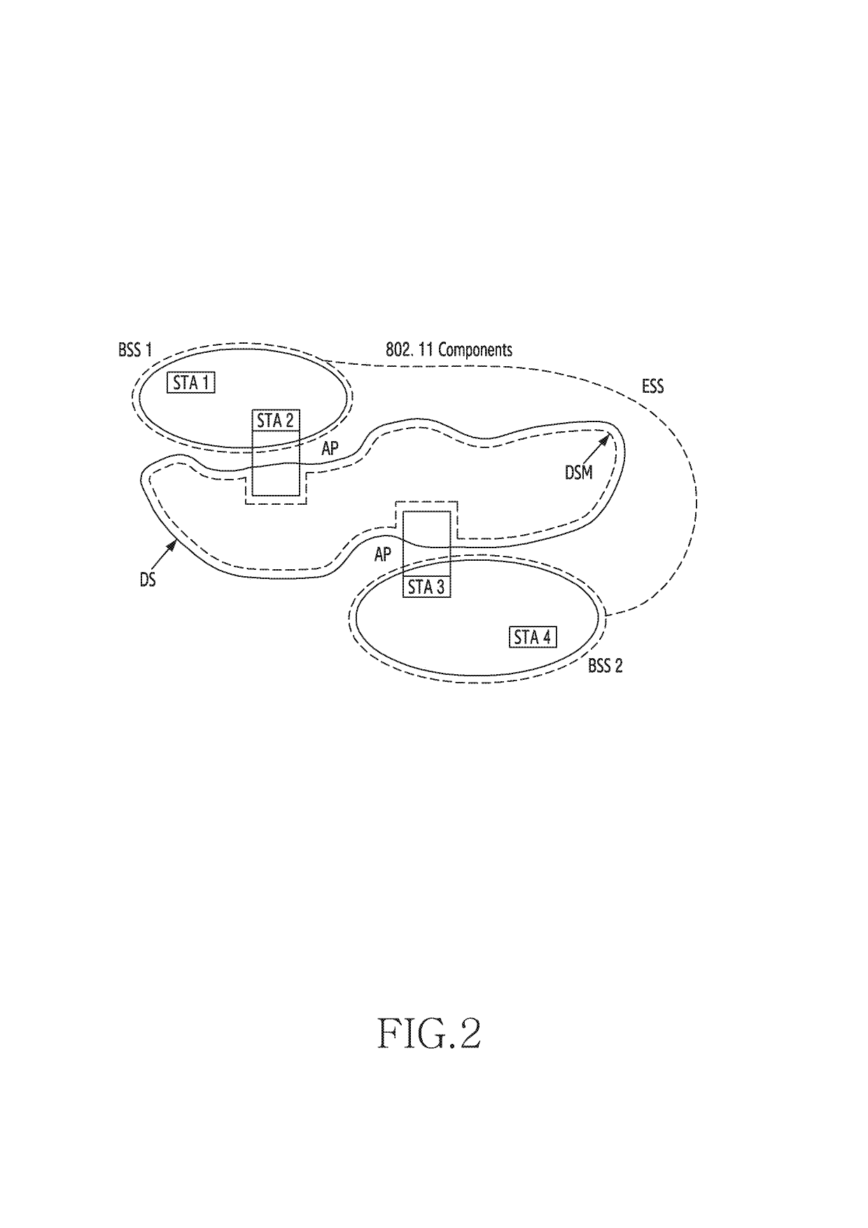

FIG. 2 illustrates a structure of a wireless LAN system according to an embodiment of the disclosure.

A wireless LAN system may have a structure comprised of multiple components. A wireless LAN system may support transparent STA mobility to upper layers through the interaction of multiple components. A basic service set (BSS) is the fundamental building block of a wireless LAN. FIG. 2 illustrates two BSSs (BSS 1 and BSS 2), each of which includes two STAs as members (STA 1 and STA 2 are included in BSS 1, and STA 3 and STA 4 are included in BSS 2). The oval representing a BSS in FIG. 2 may also be understood as representing a coverage area in which STAs included in the corresponding BSS maintain communication. This area may be referred to as a basic service area (BSA). If an STA moves outside the BSA, the STA cannot communicate directly with other STAs within the BSA.

Without considering the distributed system (DS) illustrated in FIG. 2, the most basic type of BSS in a wireless LAN is an Independent BSS (IBSS). For example, an IBSS may have a minimal form consisting of only two STAs. For example, assuming other components are omitted, BSS 1 consisting of only STA 1 and STA 2, or BSS 2 consisting of only STA 3 and STA 4, are representative examples of the IBSS. Such configurations are possible when STAs may communicate directly without an AP. In addition, this type of WLAN is not planned in advance but may be configured when a local area network (LAN) is required, and may be referred to as an ad-hoc network. Because the IBSS does not include an AP, there is no centralized management entity. In other words, STAs in the IBSS are managed in a distributed manner. In the IBSS, all STAs may be made up of mobile STAs, and access to DS is not allowed, forming a self-contained network.

The membership of the STA in the BSS may be dynamically changed by turning on or off the STA, entering or leaving the BSS area, and the like. In order to become a member of the BSS, the STA may join the BSS by using a synchronization process. In order to access all services of the BSS infrastructure, the STA must be associated with the BSS. This association may be dynamically configured and may include the use of a distribution system service (DSS).

In a wireless LAN, the direct STA-to-STA distance may be limited by PHY performance. In some cases, this limitation of distance may be sufficient, but in other cases, communication between STAs over longer distances may be required. A DS may be configured to support extended coverage.

DS refers to a structure in which BSSs are interconnected. Specifically, a BSS may exist as an extended component of a network composed of multiple BSSs, as illustrated in FIG. 2. DS is a logical concept and may be specified by the characteristics of the distributed system medium (DSM, DS medium). In this regard, the wireless medium (WM) and DSM may be logically distinguished. Each logical medium is used for a different purpose and by different components. These media are neither limited to being identical nor limited to being different. This logical difference between multiple media explains the flexibility of the WLAN structure (DS structure or other network structures). That is, the wireless LAN structure may be implemented in various ways, and the corresponding wireless LAN structure may be independently specified by the physical characteristics of each implementation.

A DS may support mobile devices by providing seamless integration of multiple BSSs and the logical services necessary to handle destination addresses. In addition, a DS may include a component called a portal, which acts as a bridge for connecting a wireless LAN to another network (e.g., IEEE 802.X).

An AP enables non-AP STAs associated with the AP to access the DS through the WM. The AP may refer to an entity that also has STA functionality, and data may be transferred between the BSS and the DS through the AP. For example, STA 2 and STA 3 shown in FIG. 2 provide a function that allows associated non-AP STAs (STA 1 and STA 4) to access DS while having the STA functionality. In addition, since all APs are essentially STAs, all APs are addressable entities. The address used by the AP for communication on the WM and the address used by the AP for communication on the DSM do not necessarily need to be identical. A BSS comprised of an AP and one or more STAs may be referred to as an infrastructure BSS.

Data transmitted from one of the STAs associated with an AP to the STA address of the corresponding AP is always received on an uncontrolled port and may be processed by the IEEE 802.1X port access entity. In addition, if a controlled port is authenticated, the transmitted data (or frame) may be forwarded to the DS.

In addition to the DS structure described above, an extended service set (ESS) may be configured to provide broader coverage.

The ESS is a network having an arbitrary size and complexity, and may correspond to a set of BSSs connected to one DS. However, the ESS does not include a DS. An ESS network is characterized by being viewed as an IBSS at the logical link control (LLC) layer. STAs within the ESS may communicate with each other, and mobile STAs may transparently move from one BSS to another ESS (i.e., within the same ESS) to the LLC. APs included in one ESS may have the same service set identifier (SSID). The SSID is distinguished from a BSSID (BSS SSID), which is an identifier of the BSS.

A wireless LAN system makes no assumptions about the relative physical locations of BSSs, and all of the following forms are possible. BSSs may partially overlap, which is a form commonly used to provide continuous coverage. In addition, BSSs may not be physically connected, and logically, there is no limit to the distance between the BSSs. In addition, BSSs may be located in the same physical location, which may be used to provide redundancy. In addition, one or more IBSS or ESS networks may physically exist in the same space as one (or more) ESS networks. This may correspond to the type of ESS network, such as when an ad-hoc network operates in a location where the ESS network exists, when physically overlapping wireless networks are configured by different organizations, or when two or more different access and security policies are required in the same location.

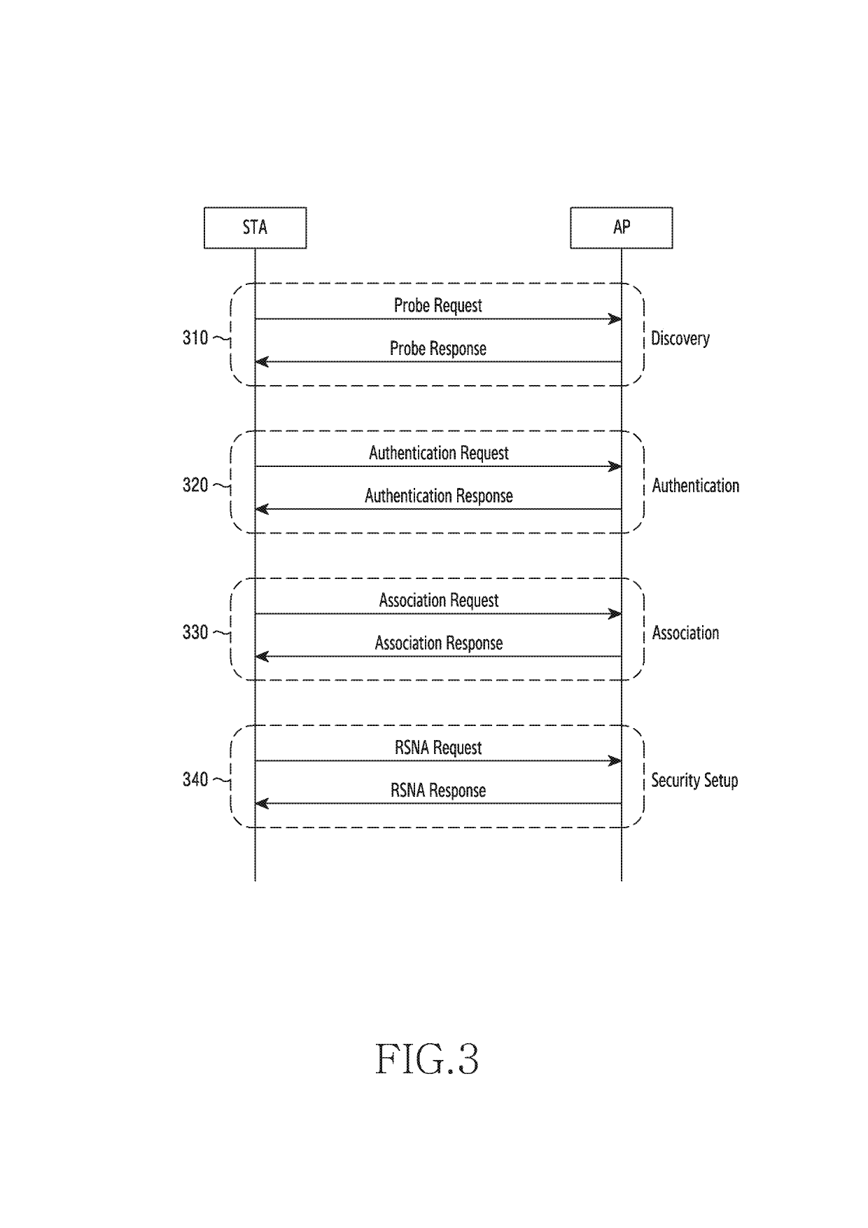

FIG. 3 illustrates a link setup process according to an embodiment of the disclosure.

For an STA to set up a link and to transmit and receive data, the STA must discover the network through an AP, perform authentication, establish an association, and set up security. The link setup process may also be referred to as the session initiation process or session setup process. In addition, the process of discovery, authentication, association, and security configuration of the link setup process may be collectively referred to as the association process.

In step 310, the STA may perform a network discovery operation. The network discovery operation may include a scanning operation of the STA. That is, to access a network, the STA must discover an available network. Before joining the wireless network, the STA must identify compatible networks, and the network identification process in a specific area is called scanning.

Scanning methods include active scanning and passive scanning. FIG. 3 illustrates a network discovery operation including an active scanning process as an example. In active scanning, the STA performing scanning transmits a probe request frame to discover which APs exist around the channels while moving between channels and waits for a response. The responder transmits a probe response frame to the STA that has transmitted the probe request frame in response to the probe request frame. The responder may be an STA that last transmitted a beacon frame in the BSS of the channel being scanned. In the BSS, the AP transmits the beacon frame, so the AP becomes the respondent, and in the IBSS, the respondents are not fixed because the STAs in the IBSS take turns transmitting the beacon frame. For example, an STA that transmits a probe request frame on channel 1 and receives a probe response frame on channel 1 may store the BSS-related information included in the received probe response frame and move to the next channel (e.g., channel 2) to perform scanning in the same manner (i.e., transmitting a probe request and receiving a response on channel 2).

Although not illustrated in FIG. 3, the scanning operation may be performed in a passive scanning method. The STA that performs scanning in passive scanning moves between channels and waits for a beacon frame. The beacon frame is one of the management frames defined in IEEE 802.11 and is periodically transmitted to notify the existence of the wireless network and to allow the STA performing scanning to find the wireless network and participate in the wireless network. In the BSS, the AP periodically transmits the beacon frame, and in the IBSS, the STAs in the IBSS take turns transmitting the beacon frame. Upon receiving the beacon frame, the STA that performs scanning stores information on the BSS included in the beacon frame and records beacon frame information on each channel while moving to another channel. Upon receiving the beacon frame, the STA may store BSS-related information included in the received beacon frame and move to the next channel to perform scanning on the next channel in the same way. Comparing active scanning with passive scanning, active scanning has the advantage of less delay and power consumption than passive scanning.

After the STA discovers the network, an authentication process may be performed in step 320. This authentication process may be referred to as a first authentication process to clearly distinguish the authentication process from the security setup operation described below in step 340.

The authentication process includes a process in which the STA transmits an authentication request frame to the AP and the AP transmits an authentication response frame to the STA in response. The authentication request frame and the authentication response frame used in the authentication process belong to the management frame.

The authentication frame may include information on an authentication algorithm number, an authentication transaction sequence number, a status code, a challenge text, a robust security network (RSN), a finite cyclic group, and the like. This corresponds to some examples of information that may be included in the authentication request/response frame, and may be replaced with other information, or additional information may be further included.

The STA may transmit an authentication request frame to the AP. The AP may determine whether to allow authentication for the corresponding STA based on the information included in the received authentication request frame. The AP may provide the result of the authentication processing to the STA through the authentication response frame.

After the STA is successfully authenticated, an association process may be performed in step 330. The association process includes a process in which the STA sends an association request frame to the AP and the AP sends an association response frame to the STA in response.

The association request frame may include information related to various capabilities and information on beacon listen interval, service set identifier (SSID), supported rates, supported channels, robust security network (RSN), mobility domain, supported operating classes, traffic indication map (TIM) broadcast request, and interworking service capabilities. For example, the association response frame may include information related to various capabilities and information on status codes, association ID (AID), supported rates, enhanced distributed channel access (EDCA) parameter sets, received channel power indicator (RCPI), received signal to noise indicator (RSNI), mobility domain, timeout interval (e.g., association comeback time), overlapping BSS scan parameters, TIM broadcast response, and quality of service (QoS) maps. This corresponds to some examples of information that may be included in the association request/response frames, and the association request/response frames may further include other additional information.

After the STA is successfully associated with the network through the AP, a security setup process may be performed in step 340. The security setup process in step 340 may include an authentication process through a robust security network association (RSNA) request/response. In addition, if the authentication process in step 320 is called the first authentication process, the security setup process in step 340 may also be referred to simply as an authentication process.

The security setup process in step 340 may include, for example, a private key setup process by using 4-way handshaking through an extensible authentication protocol over LAN (EAPOL) frame. In addition, the security setup process may be performed according to a security scheme not defined in the IEEE 802.11 standard.

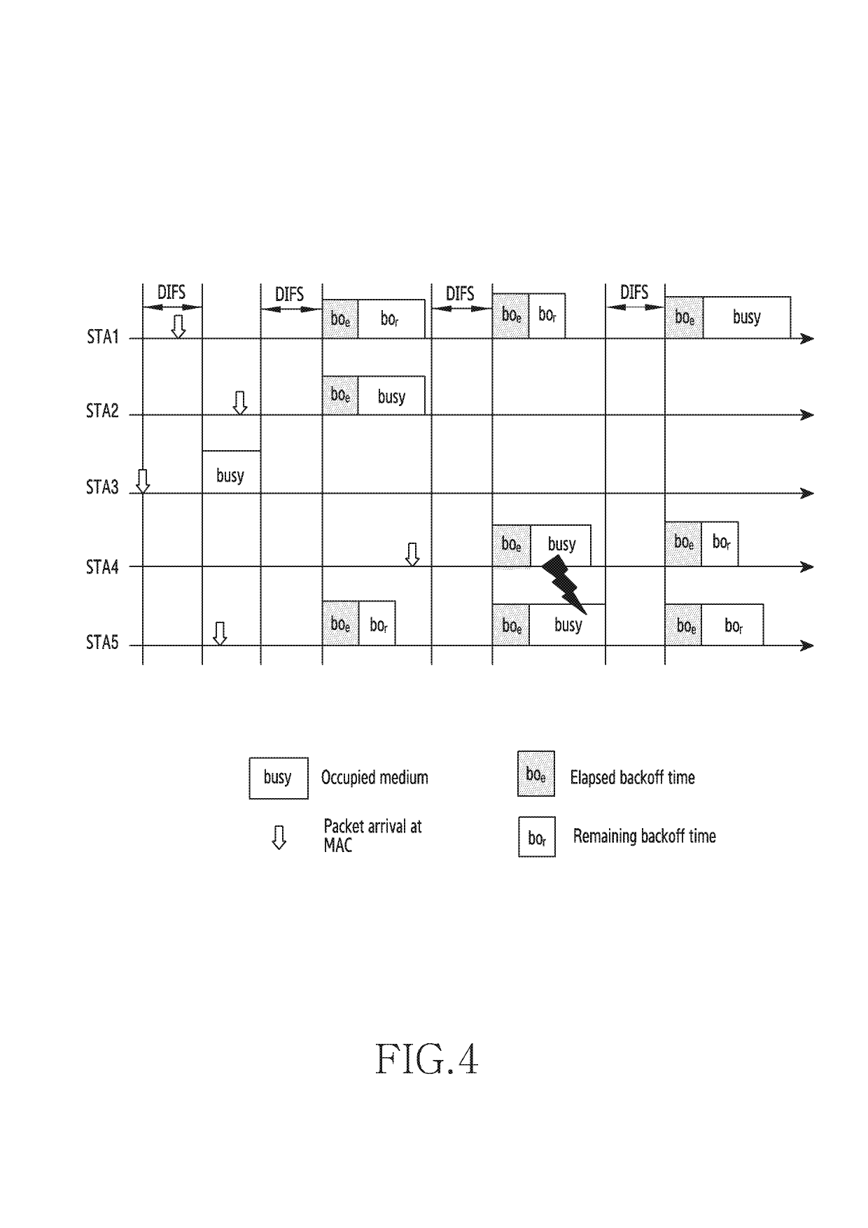

FIG. 4 illustrates a backoff operation according to an embodiment of the disclosure.

In a wireless LAN system, the basic access mechanism for MAC is the carrier sense multiple access with collision availability (CSMA/CA) mechanism. The CSMA/CA mechanism, also known as the distributed coordination function (DCF) of the IEEE 802.11 MAC, essentially employs a "listen before talk" access mechanism. According to this type of access mechanism, before starting transmission, the AP and/or STA performs clear channel assessment (CCA), which senses a wireless channel or medium for a predetermined time period (e.g., the DCF Inter-Frame Space (DIFS). If it is determined that the medium is in an idle state as a result of sensing, the AP and/or STA starts frame transmission through the medium. On the other hand, if the medium is detected as occupied or in a busy status, the AP and/or STA may attempt frame transmission after waiting for a predetermined delay period (e.g., a random backoff period) for medium access without starting its own transmission. Through the application of the random backoff period, multiple STAs wait for different periods of time before attempting frame transmission, thereby minimizing collisions.

In addition, the IEEE 802.11 MAC protocol provides hybrid coordination function (HCF). HCF is based on the DCF and point coordination function (PCF). PCF is a polling-based synchronous access method that periodically polls all receiving APs and/or STAs to receive data frames. In addition, HCF also includes enhanced distributed channel access (EDCA) and HCF controlled channel access (HCCA). EDCA is a contention-based access method that allows providers to provide data frames to multiple users, while HCCA uses a non-contention-based channel access method using a polling mechanism. In addition, HCF includes a medium access mechanism to enhance the quality of service (QoS) of wireless LANs, and may transmit QoS data in both contention period (CP) and contention free period (CFP).

An operation based on a random backoff period is described with reference to FIG. 4. When an occupied/busy medium is changed to an idle state, multiple STAs may attempt to transmit data (or frame). As a way to minimize collisions, STAs may each select a random backoff count and wait for a corresponding slot time, and then attempt transmission. The random backoff count has a pseudo-random integer value, and may be determined as one of values in the range of 0 to CW. CW is a contention window parameter value. The CW parameter is initially set to CWmin, but in the case of a transmission failure (e.g., if an ACK for a transmitted frame is not received), the STA may double the CW. Once the CW parameter value reaches CWmax, the STA may attempt data transmission while maintaining the CWmax value until the data transmission is successful, and if the data transmission is successful, the STA resets the CW to the CWmin value. The values of CW, CWmin, and CWmax may be configured to 2n-1 (n=0, 1, 2, ...).

Once the random backoff process starts, the STA continues to monitor the medium while counting down the backoff slots according to the determined backoff count value. If the medium is monitored as occupied, the countdown stops and waited, and if the medium becomes idle, the remaining countdown is resumed.

Referring to FIG. 4, when a packet to be transmitted reaches the MAC of the STA3, the STA3 may identify that the medium is in an idle state as much as DIFS and may immediately transmit a frame. The remaining STAs monitor the medium for occupied/busy states and wait. In the meantime, data to be transmitted may also occur in each of STA1, STA2, and STA5, and each STA may wait as long as DIFS when the medium is identified to be idle, and then count down the backoff slot according to the random backoff count value selected by each. It is assumed that STA2 selects the smallest backoff count value and STA1 selects the largest backoff count value. That is, a case, in which STA5's remaining backoff time is shorter than STA1's remaining backoff time when STA2 completes the backoff count and starts frame transmission, is illustrated. STA1 and STA5 pause their countdown and wait while STA2 occupies the medium. When STA2's occupancy ends and the medium becomes idle again, STA1 and STA5 wait as long as DIFS before resuming the stopped backoff count. That is, the STA1 and STA5 may start frame transmission after counting down the remaining backoff slots by the remaining backoff time. Since STA5's remaining backoff time is shorter than STA1's, STA5 starts frame transmission. While STA2 occupies the medium, STA4 may also have data to transmit. When the medium becomes idle, STA4 may wait as long as DIFS, perform a countdown according to the random backoff count value selected by the STA4, and start frame transmission. The example in FIG. 4 illustrates a case where STA5's remaining backoff time coincides with STA4's random backoff count value, and in this case, a collision may occur between STA4 and STA5. If a collision occurs, neither STA4 nor STA5 will receive an ACK, resulting in a data transmission failure. In this case, STA4 and STA5 may double the CW value, select a random backoff count value, and then perform a countdown. STA1 may wait while the medium is occupied due to the transmission of STA4 and STA5, wait as long as DIFS when the medium is idle, and then start frame transmission after the remaining backoff time.

As shown in the example in of FIG. 4, a data frame is a frame used for data transmission to an upper layer, and may be transmitted after a backoff performed after DIFS has elapsed from since the medium becomes idle. In addition, a management frame is a frame used for the exchange of management information without being transmitted to the upper layer and is transmitted after a backoff performed after IFS, such as DIFS or point coordination function IFS (PIFS). The management frame is a subtype frame and may include a beacon, an association request/response, a re-association request/response, a probe request/response, an authentication request/response, and the like. A control frame is a frame used to control access to a medium. The control frame may include subtypes such as request-to-send (RTS), clear-to-send (CTS), acknowledgment (ACK), power save-poll (PS-Poll), block ACK (B-ACK or BlockAck), block ACK request (BlockACKReq), null data packet announcement (NDP), and trigger. The control frame is transmitted after the backoff performed after DIFS has elapsed if the control frame is not the response frame of the previous frame, and in the case of the response frame of the previous frame, the control frame is transmitted without performing the backoff after SIFS (short IFS). The type and subtype of the frame may be identified by a type field and a subtype field in a frame control (FC) field.

The quality of service (QoS) STA may transmit a frame after a backoff performed after the arbitration IFS (AIFS) for an access category (AC), that is, AIFS[i] (where i is a value determined by the AC), to which the frame belongs. Here, the frame in which AIFS[i] may be used may be a data frame, a management frame, or a control frame rather than a response frame.

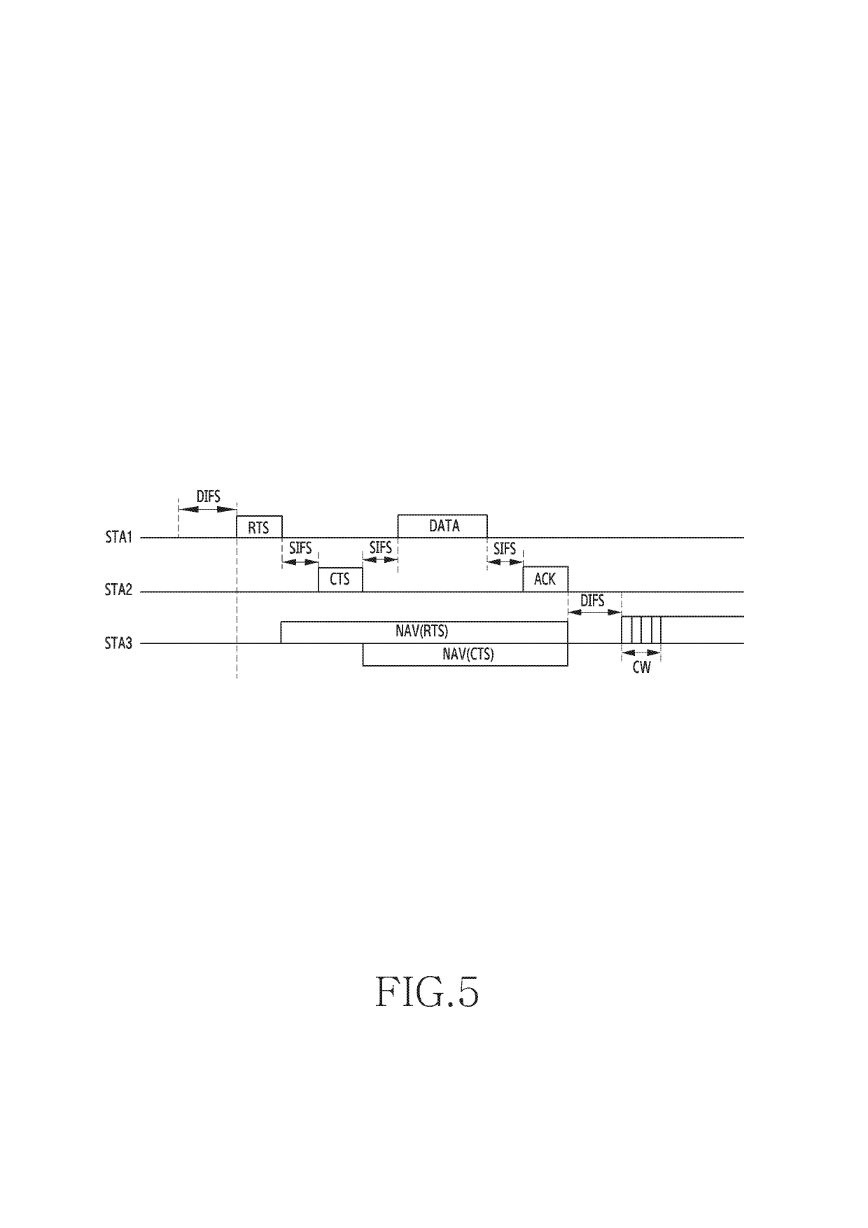

FIG. 5 illustrates a carrier sense multiple access with collision avoidance (CSMA/CA)-based frame transmission according to an embodiment of the disclosure.

As described above, the CSMA/CA mechanism includes virtual carrier sensing as well as physical carrier sensing in which STA directly senses the medium. The virtual carrier sensing is intended to compensate for a problem that may occur in media access, such as a hidden node problem. For the virtual carrier sensing, the MAC of the STA may use a network allocation vector (NAV). The NAV is a value that indicates to another STA the remaining time until the medium becomes available for use by the STA that is currently using the medium or is authorized to use the medium remains available. Therefore, the NAV value corresponds to the period during which the STA transmitting the frame is scheduled to use the medium, and the STA receiving the NAV value is prohibited from accessing the medium during that period. For example, the NAV may be configured based on the value of the "duration" field in the frame's MAC header.

Referring to FIG. 5, STA1 intends to transmit data to STA2, and STA3 is in a position to overhear part or all of the frames transmitted and received between the STA1 and the STA2.

To reduce the possibility of transmission collisions between multiple STAs in CSMA/CA-based frame transmission operations, a mechanism utilizing RTS/CTS frames may be applied. In the example of FIG. 5, while transmission of the STA1 is performed, it may be determined that a carrier sensing result medium of the STA3 is in an idle state. That is, the STA1 may correspond to a hidden node to the STA3. Alternatively, in the example of FIG. 5, it may be determined that the carrier sensing result medium of the STA3 is in an idle state while transmission of the STA2 is performed. That is, the STA2 may correspond to a hidden node to the STA3. By exchanging RTS/CTS frames before performing data transmission and reception between the STA1 and the STA2, an STA outside the transmission range of either STA1 or STA2 or an STA outside the carrier sensing range for transmissions from the STA1 or the STA3 may not attempt to occupy a channel during data transmission or reception between the STA1 and the STA2.

Specifically, the STA1 may determine whether a channel is being used through carrier sensing. In terms of physical carrier sensing, the STA1 may determine the channel occupancy idle state based on the energy level or signal correlation detected in the channel. In addition, in terms of virtual carrier sensing, STA1 may use the NAV timer to determine the channel occupancy state.

When a channel is in an idle state during DIFS, the STA1 may transmit an RTS frame to the STA2 after performing a backoff. Upon receiving the RTS frame, the STA2 may transmit a CTS frame, which is a response to the RTS frame, to the STA1 after SIFS.

If the STA3 cannot overhear the CTS frame from the STA2 but may overhear the RTS frame from the STA1, the STA3 may use the duration information included in the RTS frame to configure the NAV timer for the frame transmission period continuously transmitted thereafter (e.g., SIFS + CTS frame + SIFS + data frame + SIFS + ACK frame). Alternatively, if the STA3 cannot overhear the RTS frame from the STA1 but may overhear the CTS frame from the STA2, the STA3 may use the duration information included in the CTS frame to configure the NAV timer for the frame transmission period continuously transmitted thereafter (e.g., SIFS + data frame + SIFS + ACK frame). That is, if the STA3 may overhear one or more RTS or CTS frames from either the STA1 or the STA2, the NAV may be configured accordingly. When the STA3 receives a new frame before the NAV timer expires, the STA3 may update the NAV timer by using duration information included in the new frame. The STA3 does not attempt channel access until the NAV timer expires.

When receiving the CTS frame from the STA2, the STA1 may transmit a data frame to the STA2 after SIFS from the time when the reception of the CTS frame is completed. If the data frame is successfully received, the STA2 may transmit an ACK frame, which is a response to the data frame, to the STA1 after SIFS. When the NAV timer has expired, the STA3 may determine whether a channel is being used through carrier sensing. If it is determined that the channel is not used by another UE during DIFS after the expiration of the NAV timer, STA3 may attempt channel access after the contention window (CW) according to the random backoff has elapsed.

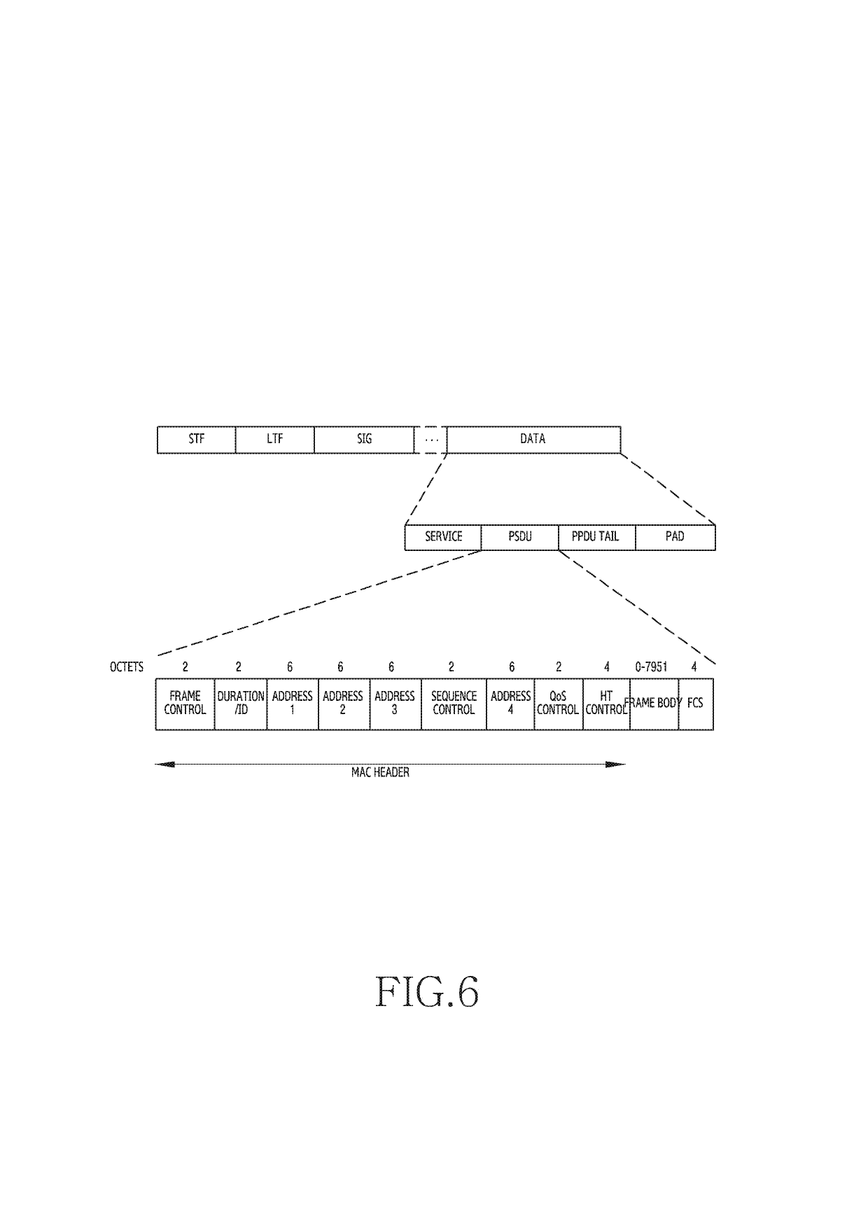

FIG. 6 illustrates a format of a frame used in a wireless LAN system according to an embodiment of the disclosure.

Based on an instruction or primitive (a set of instructions or parameters) from the MAC layer, the PHY layer may prepare a MAC PDU (MPDU) to be transmitted. When the PHY layer receives an instruction requesting the start of transmission from the MAC layer, the PHY layer switches to the transmission mode and transmits the information (e.g., data) provided by the MAC layer in the form of a frame. In addition, when the PHY layer detects a valid preamble of the received frame, the PHY layer may monitor the preamble header and transmit an instruction notifying the start of reception of the PHY layer to the MAC layer.

In this way, information transmission/reception in a wireless LAN system is performed in the form of a frame, and for this purpose, a PHY layer protocol data unit (PPDU) frame format is defined.

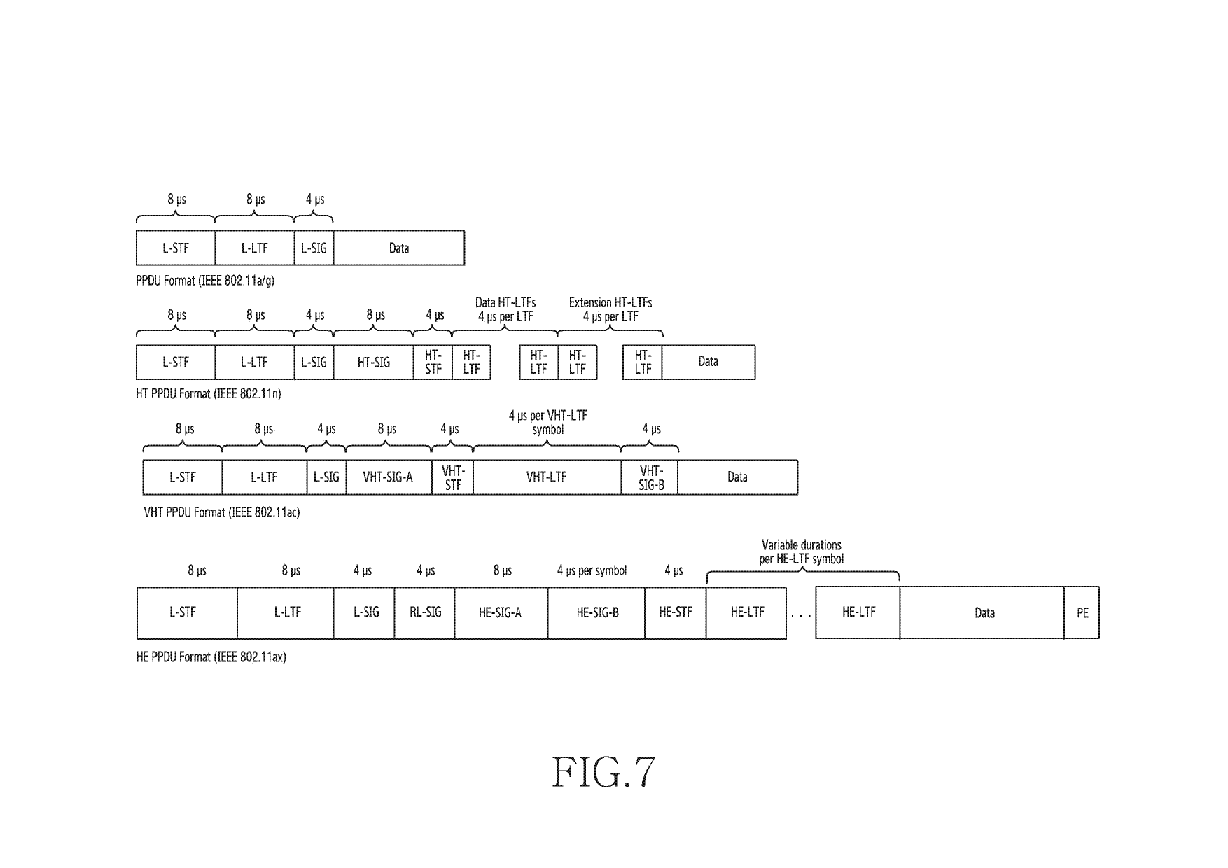

The basic PPDU frame may include a short training field (STF), a long training field (LTF), a SIG (SIGNAL) field, and a data field. The most basic (e.g., non-high throughput (HT)) PPDU frame format may consist of only the legacy-STF (L-STF), legacy-LTF (L-LTF), SIG field, and data field. In addition, depending on the type (e.g., HT-mixed format PPDU, HT-greenfield format PPDU, very high throughput (VHT) PPDU, etc.) of PPDU frame format, additional (or other) STF, LTF, and SIG fields may be included between the SIG field and the data field. A detailed type of frame format is described later with reference to FIG. 7.

STF is a signal for signal detection, automatic gain control (AGC), diversity selection, precise time synchronization, etc., and LTF is a signal for channel estimation, frequency error estimation, etc. STF and LTF are signals for synchronization and channel estimation of orthogonal frequency division multiplexing (OFDM) physical layers.

The SIG field may include a RATE field, a LENGTH field, etc. The RATE field may include information on modulation and coding rates of data. The LENGTH field may include information on the length of the data. In addition, the SIG field may include a parity bit, a SIG TAIL bit, etc.

The data field may include a SERVICE field, a physical layer service data unit (PSDU), and a PPDU TAIL bit, and may include a padding bit if necessary. Some bits of the SERVICE field may be used for synchronization of a descrambler at a receiving end. The PSDU corresponds to a MAC PDU defined in the MAC layer and may include data generated/used in an upper layer. The PPDU TAIL bit may be used to return the encoder to state 0. The padding bit may be used to adjust the length of the data field in a predetermined unit.

The MAC PDU is defined according to various MAC frame formats, and the basic MAC frame consists of a MAC header, a frame body, and a frame check sequence (FCS). The MAC frame is composed of MAC PDUs and may be transmitted and received through the PSDU of a data portion of the PPDU frame format.

The MAC header includes a frame control field, a duration/ID field, an address field, etc. The frame control field may include control information required for frame transmission/reception. The duration/ID field may be configured to a time required for transmitting the corresponding frame. Details of the sequence control, QoS control, and HT Control subfields of the MAC header are omitted.

Although not illustrated in FIG. 6, a null data packet (NDP) frame format refers to a frame format that does not include a data packet. That is, the NDP frame refers to a frame format that includes a physical layer convergence procedure (PLCP) header part (i.e., STF, LTF, and SIG fields) in a normal PPDU frame format but does not include the rest (i.e., data fields). The NDP frame may be referred to as a short frame format.

FIG. 7 illustrates a format of a physical layer protocol data unit (PPDU) of a wireless LAN system according to an embodiment of the disclosure.

Standards such as IEEE 802.11a/g/n/ac/ax/be use various PPDU formats. The basic PPDU format (IEEE 802.11a/g) includes the L-LTF, L-STF, L-SIG, and Data fields. The basic PPDU format may also be referred to as the non-HT PPDU format.

The HT PPDU format (IEEE 802.11n format) includes the HT-SIG, HT-STF, and HT-LFT(s) fields in addition to the basic PPDU format. The HT PPDU format illustrated in FIG. 7 may be referred to as the HT-mixed format. Although not illustrated, an HT-greenfield format PPDU may be defined, and this format does not include the L-STF, L-LTF, and L-SIG fields, but instead consists of the HT-GF-STF, HT-LTF1, HT-SIG, one or more HT-LTF fields, and the Data field.

The VHT PPDU format (IEEE 802.11ac format) includes VHT SIG-A, VHT-STF, VHT-LTF, and VHT-SIG-B fields in addition to the basic PPDU format.

The HE PPDU format (IEEE 802.11ax format) includes the Repeated L-SIG (RL-SIG), HE-SIG-A, HE-SIG-B, HE-STF, HE-LTF(s), and packet extension (PE) field in addition to the basic PPDU format. Depending on specific examples of the HE PPDU format, some fields may be excluded or their lengths may vary. For example, the HE-SIG-B field is included in the multi-user (MU) HE PPDU format, while the HE-SIG-B field is not included in the single-user (SU) HE PPDU format. In addition, the HE trigger-based (TB) PPDU format does not include the HE-SIG-B field, and the HE-STF field length may vary to 8μs. The extended range (HEER) SU PPDU format does not include the HE-SIG-B field, and the length of the HE-SIG-A field may vary to 16μs.

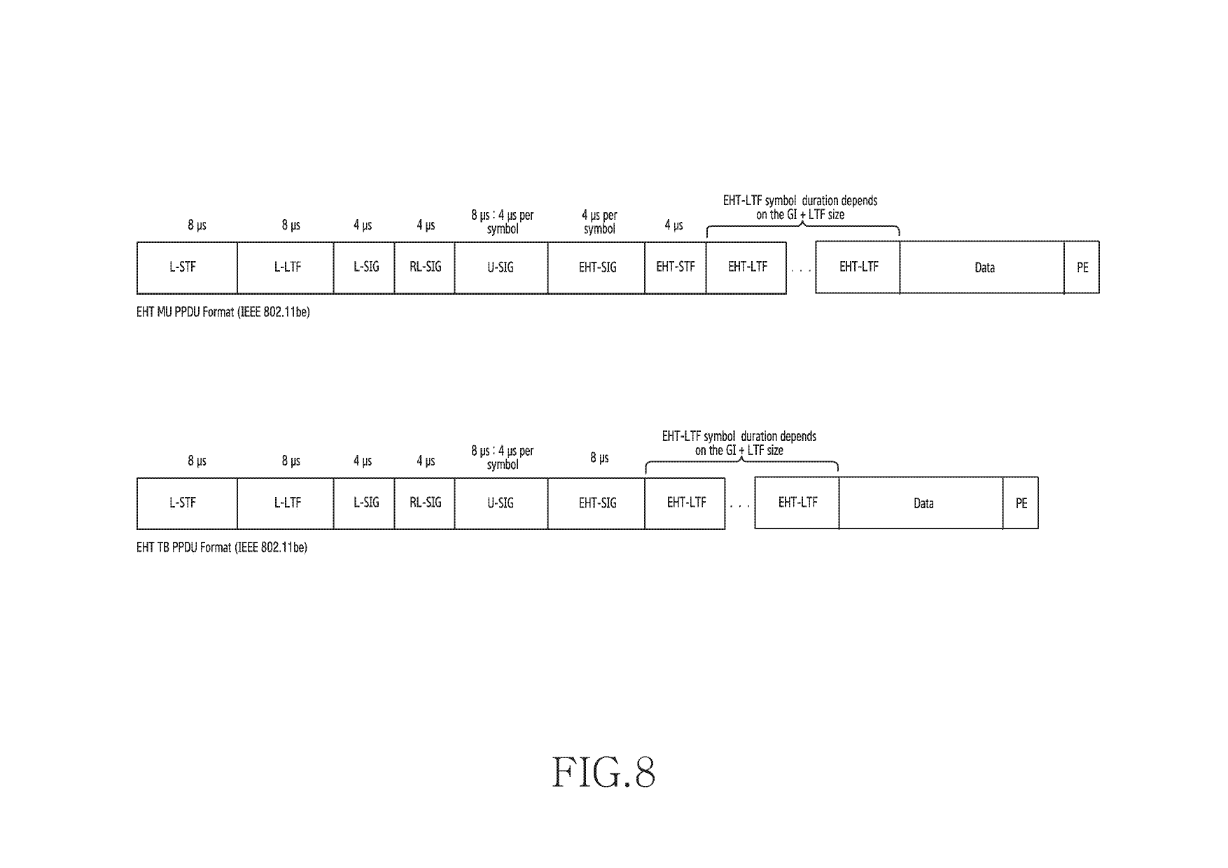

FIG. 8 illustrates another format of a PPDU of a wireless LAN system according to an embodiment of the disclosure.

The EHT PPDU format (IEEE 802.11be format) of FIG. 8 may include the EHT MU PPDU format and the EHT TB PPDU format. The EHT MU PPDU format corresponds to a PPDU carrying one or more data (or PSDUs) for one or more users. The EHT MU PPDU may be used for both SU and MU transmissions, and the EHT MU PPDU may correspond to a PPDU for one receiving STA or multiple receiving STAs. The EHT TB PPDU omits the EHT-SIG compared to the EHT MU PPDU. The STA receiving the trigger (e.g., trigger frame or RTS frame) for UL MU transmission may perform UL transmission based on the EHT TB PPDU format.

In addition to the basic PPDU format, the EHT PPDU format includes the RL-SIG, universal SIG (U-SIG), EHT-SIG, EHT-STF, EHT-LTF(s), and PE fields. Depending on detailed examples of the EHT PPDU format, some fields may be excluded or their lengths may vary. For example, depending on the EHT MU PPDU format and the EHT TB PPDU format described above, some fields of the EHT PPDU format may or may not be included, or the length of a specific field may vary.

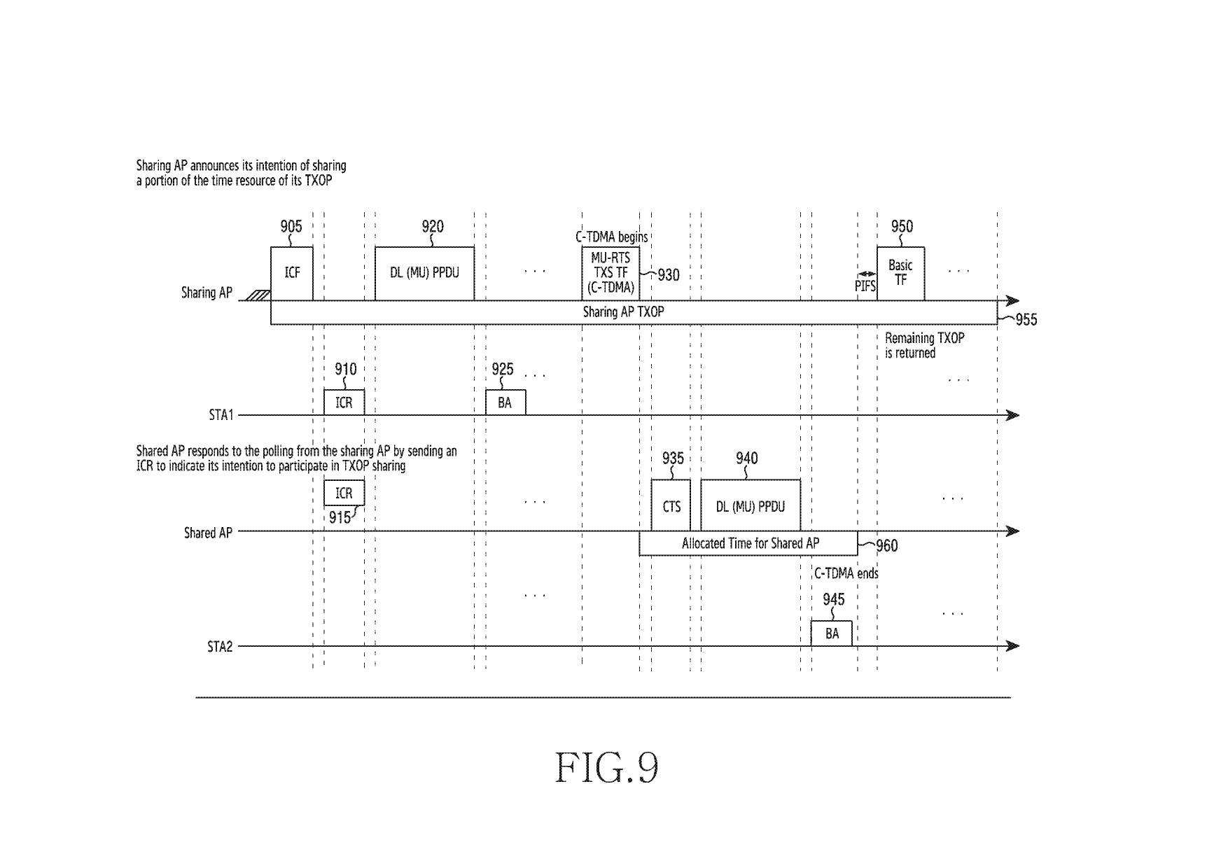

FIG. 9 is a diagram illustrating operations of coordinated time division multiple access (C-TDMA) in a wireless LAN system according to an embodiment of the disclosure.

As discussions on the 802.11bn standard progress, various proposals to improve C-TDMA are being discussed. C-TDMA refers to a procedure by which a specific AP shares its acquired TXOP time resources with a set of other APs, and may be called TXOP sharing (TXS) because C-TDMA is a procedure for sharing TXOP.

An AP that shares its acquired TXOP with other APs in C-TDMA or TXS may be called a sharing AP. The sharing AP announces its intention of sharing at least a portion of the acquired TXOP's time resources, and this may be accomplished by transmitting an initial control frame (ICF) 905 at the start of the TXOP. The ICF transmitted by the sharing AP may poll the interest of the target APs with which the sharing AP will share the TXOP, and the AP that shares a portion of the TXOP acquired by the sharing AP may be called a shared AP or a polled AP. The names sharing AP, shared AP, and polled AP are just one example of calling APs participating in C-TDMA and TXS, and it is natural that they may be called other names instead of the names mentioned above.

The ICF 905 transmitted by the sharing AP may include a duration field, and the duration field of the ICF 905 may be configured to a value for indicating a time length acquired by adding SIFS to a time for transmitting an initial control response (ICR) that is a response to the ICF 905. The ICF 905 transmitted by the sharing AP may be transmitted to STA1 that is an associated STA of the sharing AP and a shared AP adjacent to the sharing AP, and the STA1 receiving the ICF 905 may transmit an initial control response (ICR) to the sharing AP in response to the ICF (910). The shared AP receiving the ICF 905 from the sharing AP may also transmit the ICR 915 to the sharing AP in response to the ICF 905. The sharing AP transmits a DL PPDU or a DL multi-user (MU) PPDU 920 to the STA1 in its TXOP 955 and the STA1 may transmit a block ack (BA) to the sharing AP in response to the reception of the DL PPDU (925).

Meanwhile, as the sharing AP decides to share at least some of its TXOPs with the shared AP as described above, the sharing AP may transmit an MU-RTS TXS trigger frame (TF) to the shared AP to notify the start (or initiation) of C-TDMA (930). While FIG. 9 illustrates an embodiment in which a shared AP transmits an MU-RTS TXS TF to a single shared AP, the shared AP may also transmit the MU-RTS TXS TF to one or more shared APs (i.e., a set of APs). Upon receiving the MU-RTS TXS TF, the shared AP may transmit a CTS frame to the shared AP to confirm the start (or initiation) of C-TDMA (935), and transmit the DL (MU) PPDU to the STA2 which is a non-AP STA coupled to the shared AP within the time resource 960 allocated to the shared AP (940). Meanwhile, the time resource 960 allocated to the shared AP may be indicated by the allocation duration field of the MU-RTS TXS TF 930 described above. The STA2 may transmit the BA to the shared AP in response to the received DL (MU) PPDU (945). By monitoring the TXOP and confirming that there is no data transmission/reception during PIFS, the sharing AP may retrieve the TXOP shared with the shared AP, and accordingly, a basic TF may be transmitted (950) within its own TXOP to perform a separate transmission/reception procedure. The C-TDMA described in FIG. 9 is distinct from the procedure for sharing TXOP between existing APs and non-AP STAs in that TXOPs are shared between APs.

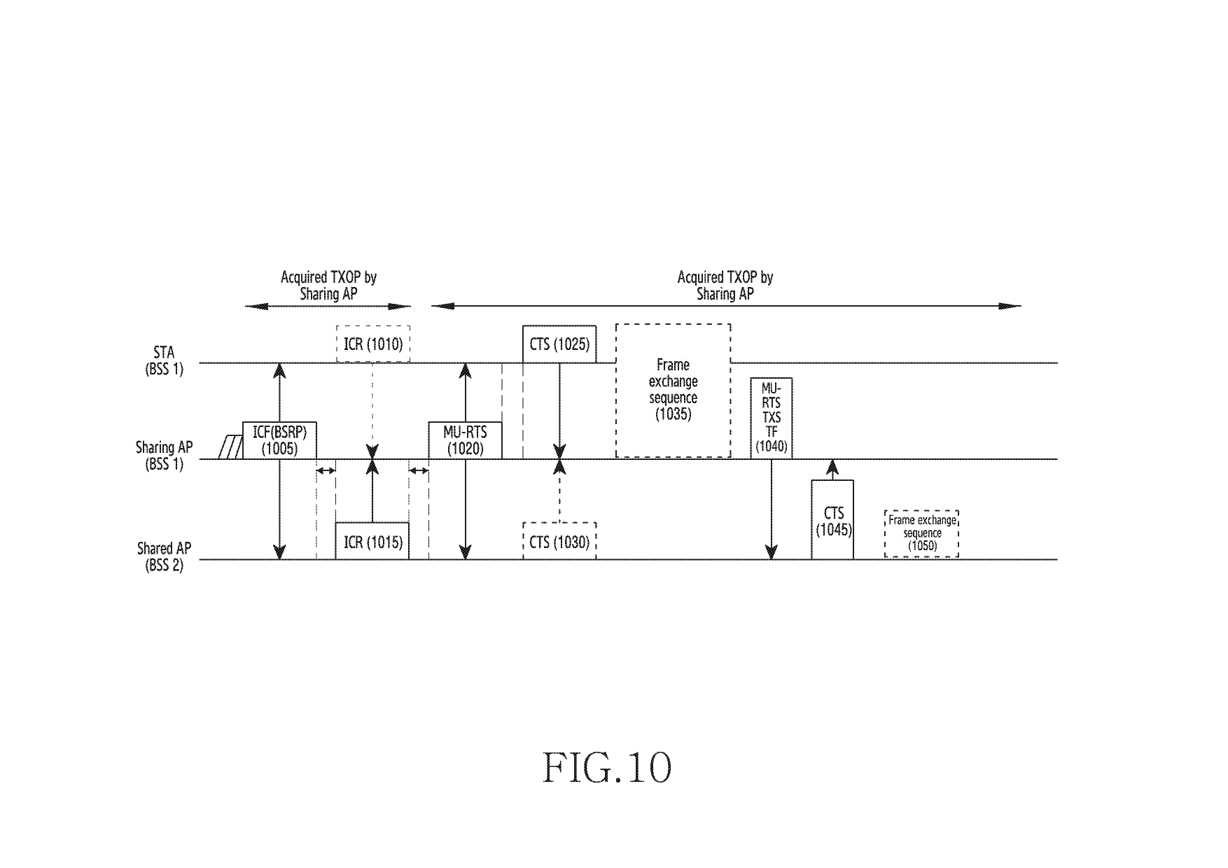

FIG. 10 is a diagram illustrating a C-TDMA (or TXS) operation according to an embodiment of the disclosure. Regarding TXS (or C-TDMA) considering DPS proposed in the disclosure, DPS is described first.

DPS is an AP power-saving operation, and operation to reduce the power consumption of APs, and APs that support DPS may perform a DPS operation by transmitting DPS capability and DPS-related parameters to non-AP STAs and neighboring APs performing multi-AP operations. The DPS operation may be performed through switching (or transition) between three modes that are high capability mode (HCM), low capability mode (LCM), and doze mode, and the AP may notify the non-AP STA and neighboring APs of the DPS mode of the AP by transmitting a frame including an indicator for indicating the DPS mode.

HCM mode (or HCM state) may refer to a state in which the AP performs all operations without limitation to the type of parameter or operation, LCM mode (or LCM state) may refer to a state in which the AP performs operations with at least some of the parameters or types of operations limited, and The doze mode (or doze state) may refer to a state in which the AP limits all (or most of) the types of parameters or operations, such that normal transmission and/or reception are impossible.

FIG. 10 illustrates that a sharing AP (related to BSS1) transmits an ICF for C-TDMA (or TXS) polling to a non-AP STAs (related to BSS1) associated with the sharing AP and shared APs (related to BSS2) (1005), and this ICF may be intended to indicate the sharing AP's intention to share some of its TXOP time resources with the shared AP and/or STA, and the ICF may include a buffer status report poll (BSRP) trigger frame. Subsequently, the non-AP STA and the shared AP that have received the ICF may transmit the ICR to the sharing AP (1010, 1015) to notify whether the non-AP STA and the shared AP will participate in the C-TDMA (or TXS), respectively.

Meanwhile, since the time period indicated by the duration field of the ICF transmitted by the sharing AP corresponds to the sum of the lengths of frames for SIFS and ICR transmission, the TXOP for ICF/ICR exchange may not be sufficient for C-TDMA (or TXS) to be performed. Therefore, TXOP to be actually performed separately from TXOP for ICF/ICR exchange should be acquired. Hereinafter, a process by which the sharing AP that has acquired the TXOP in which the C-TDMA (or TXS) is actually performed informs the shared AP and/or non-AP STA of information for scheduling the C-TDMA (or TXS). According to an embodiment, the sharing AP may inform the shared AP and/or non-AP STA of information for scheduling the TXOP in which C-TDMA (or TXS) is to be performed by transmitting the MU-RTS trigger frame 1020. This MU-RTS trigger frame 1020 is distinct from the MU-RTS TXS TF 1040 to actually announce the start (or initiation) of C-TDMA (or TXS) within the corresponding TXOP in that the MU-RTS trigger frame is intended to indicate the scheduling of the TXOP in which C-TDMA (or TXS) is to be performed. The shared AP and/or non-AP STA that receives the MU-RTS trigger frame 1020 from the sharing AP may transmit CTS frames 1025 and 1030 to the sharing AP, and the sharing AP may exchange frames with the non-AP STA associated with the sharing AP within the TXOP that the sharing AP has acquired (1035).

The sharing AP then transmits the MU-RTS TXS TF 1040 to the shared AP to announce the start (or initiation) of C-TDMA (or TXS) within the TXOP, and the shared AP transmits a CTS frame 1045 to the sharing AP in response. Through the MU-RTS TXS TF 1040, the sharing AP may specify a time period in which C-TDMA (or TXS) is to be performed within the TXOP, and then the shared AP may perform frame exchange according to C-TDMA (or TXS) (1050).

According to the above-described embodiment, the sharing AP may separately transmit a frame for transmitting the scheduling information of the TXOP in which C-TDMA (or TXS) is to be performed and a frame for notifying that C-TDMA (or TXS) is actually started (or initiated). According to the proposed embodiment, as the sharing AP transmits the MU-RTS trigger frame and the shared AP that receives the same, the sharing AP may not only transmit TXOP scheduling information for C-TDMA (or TXS), but also solve the hidden node problem located between the sharing AP and the shared AP. Meanwhile, according to another embodiment, solve the over-protection problem, the shared AP that receives the MU-RTS trigger frame from the sharing AP may not transmit a response frame such as CTS.

Hereinafter, ICF/ICR and MU-RTS trigger frames exchanged between the sharing AP and the shared AP according to the above-described embodiments will be described in detail.

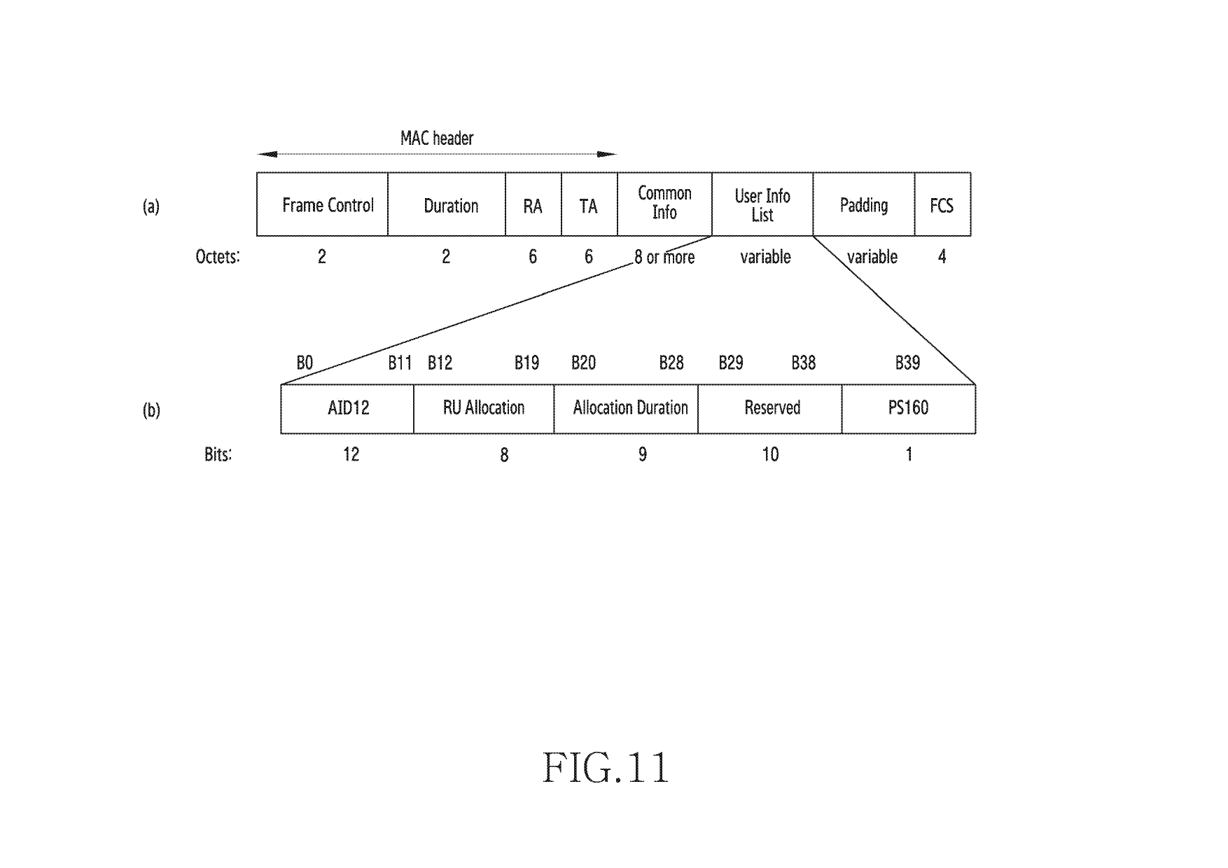

FIG. 11 is a diagram illustrating a frame format structure according to an embodiment of the disclosure. FIG. 11 describes a format structure of an ICF that is transmitted to a shared AP in order to notify a sharing AP's intention to share some of the sharing AP's TXOP time resources according to the above-described embodiment.

According to an embodiment, the allocation duration field included in the user info list field of the ICF transmitted by the sharing AP may indicate the length of the time period of the TXOP that the sharing AP intends to allocate to the shared AP. The user info list field included in the ICF transmitted by the sharing AP may include an AID12 field, and the AID12 field may indicate an AID of the shared AP to receive the ICF. The fact that the AID12 field includes the AID of the shared AP may mean that the AID capable of distinguishing the sharing AP from the shared AP is previously shared between the sharing AP and the shared AP.

Meanwhile, according to an embodiment, the ICF transmitted by the sharing AP may include a BSRP trigger frame, but another trigger frame may also be used for the ICF.

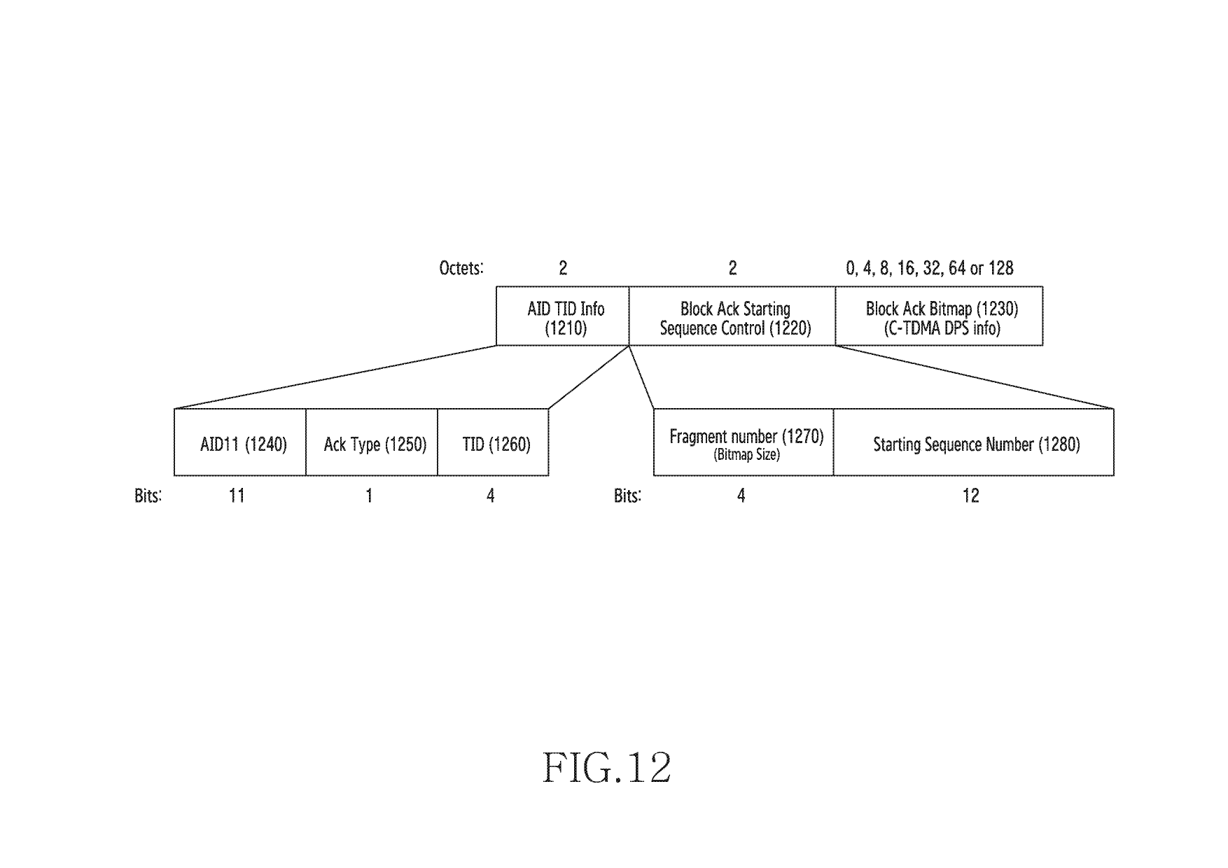

FIG. 12 is a diagram illustrating a frame format structure according to an embodiment of the disclosure. FIG. 12 illustrates a format structure of an ICR that a shared AP that receives an ICF from the sharing AP transmits to the sharing AP in response to the ICF.

According to an embodiment, the ICR transmitted by the shared AP may include an AID TID info field 1210, a block ack starting sequence control field 1220, and a block ack bitmap field 1230, and a fragment number field 1270 included in the block ack starting sequence control field 1220 may indicate the bitmap size of the block ack bitmap field 1230.

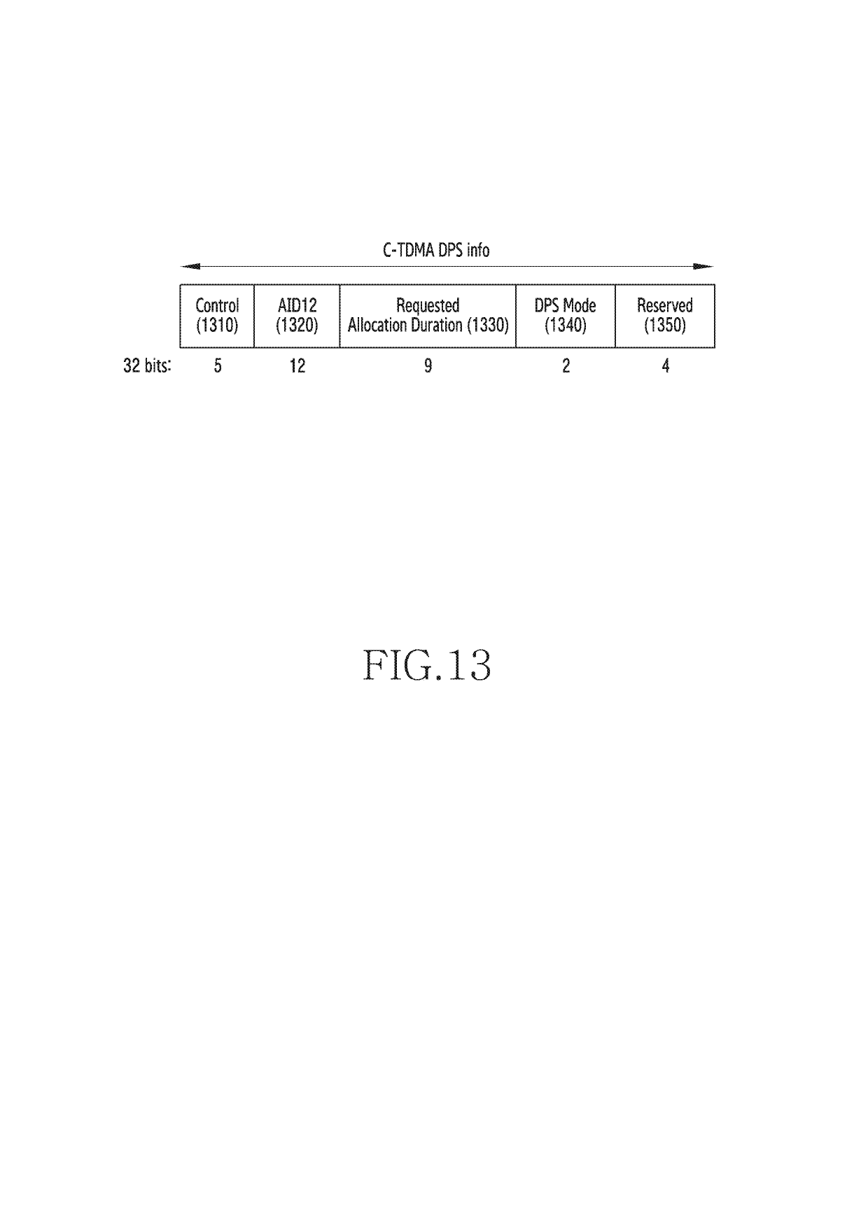

Meanwhile, the block ack bitmap field 1230 may include detailed parameters for C-TDMA (or TXS) that the shared AP intends to transmit as an ICR. For example, the block ack bitmap field 1230 may include DPS information related to C-TDMA (or TXS) of the shared AP. DPS information related to C-TDMA (or TXS) of the shared AP may indicate which DPS mode the shared AP operates in a time period other than the time interval in which C-TDMA (or TXS) is performed within the TXOP (or the time period in which C-TDMA (or TXS) is not performed), and specific embodiments are further described in FIG. 13.

Meanwhile, according to an embodiment, the ICR transmitted by the shared AP may include a multi-station block (M-BA) frame, but other trigger frames' response frames (e.g., trigger based (TB) PPDU) may be used for the ICR.

FIG. 13 is a diagram illustrating a frame format structure according to an embodiment of the disclosure. FIG. 13 illustrates a structure of a format in which DPS information related to C-TDMA (or TXS) is included in the block ack bitmap field 1230 described in FIG. 12.

Referring to FIG. 13, DPS information related to the C-TDMA (or TXS) included in the ICR may include at least one of a control field 1310, an AID12 field 1320, a requested allocation duration field 1330, a DPS mode field 1340, and a reserved bit 1350.

According to an embodiment, the ICR may utilize the control field 1310 included in the block ack bitmap field 1230 to indicate that the ICR includes a response and/or parameter related to the C-TDMA (or TXS). Alternatively, the ICR may indicate that the ICR includes a response and/or parameter related to C-TDMA (or TXS) through one of the ack type field 1250, TID field 1260, a combination of the ack type field 1250 and TID field 1260, or a starting sequence number field 1280 described in FIG. 12.

The ICR transmitted by the shared AP may include the AID12 field 1320 for identifying the sharing AP. Meanwhile, instead of the AID12 field 1320 illustrated in FIG. 13, the AID11 field 1240 or the starting sequence number field 1280 illustrated in FIG. 12 may be used as a method for identifying the sharing AP.

The shared AP may indicate the time period required by the shared AP in the TXOP in which C-TDMA (or TXS) to be started after the TXOP in which the ICF/ICR is exchanged through the ICR. For example, the requested allocation duration field 1330 included in the ICR may indicate the length of the time period required by the TXOP following the TXOP in which the shared AP transmits the ICR.

In addition, through the DPS mode field 1340 of the ICR, the shared AP may notify that in which DPS mode the shared AP operates in TXOP where C-TDMA (or TXS) after TXOP is applied following the TXOP for ICF/ICR exchange. For example, the DPS mode field 1340 may indicate in which DPS mode the shared AP operates in a period other than the time period in which C-TDMA (or TXS) is applied in the TXOP. According to an embodiment, the DPS mode field 1340 may include 2 to 8 bits, the value 0 of the DPS mode field 1340 may represent the doze state, the value 1 may represent the LCM state, and the value 2 may represent the HCM state, but the relationship between this value and the DPS mode (or the DPS state) is merely an example and other values may be utilized.

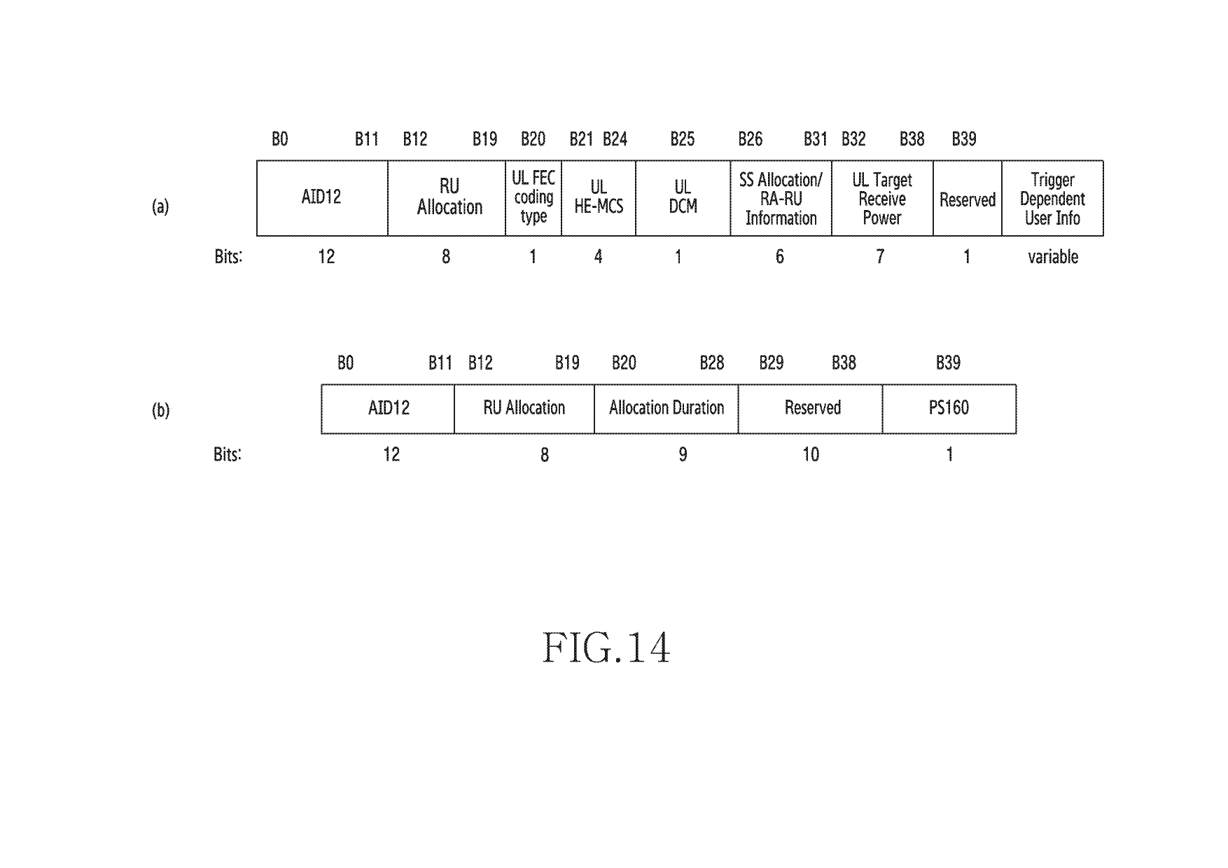

FIG. 14 is a diagram illustrating a frame format structure according to an embodiment of the disclosure. Part (a) of FIG. 14 illustrates the format structure of a frame used by a shared AP to solicit a non-AP STA, and part (b) of FIG. 14 illustrates the format structure of a frame used by a shared AP to solicit a shared AP.

In the above, the procedure and specific frame structure for exchanging ICF/ICR between the sharing AP and shared AP within TXOP have been described. Meanwhile, FIG. 14 describes a frame that the sharing AP transmits to the shared AP for scheduling the TXOP subsequent to the TXOP in which the ICF/ICR exchange is performed.

As described above, the frame transmitted by the sharing AP for TXOP scheduling may be an MU-RTS frame, and the sharing AP may acquire a new TXOP on which C-TDMA (or TXS) to be performed based on the information and parameters acquired through ICF/ICR exchange with the shared AP, and may inform the shared AP and/or the non-AP STA associated with the sharing AP of information or parameters related to the TXOP. In this case, the format structure of the frame in which the sharing AP informs the shared AP of information or parameters about the TXOP may have the format of the user info field illustrated in part (b) of FIG. 14, and the format structure of the frame in which the sharing AP informs the non-AP STA associated with the sharing AP of information or parameters about the TXOP may have a user info field format illustrated in part (a) of FIG. 14. Since the AID of the shared AP and the AID of the non-AP STA associated with the shared AP are allocated without duplication, the MU-RTS frame transmitted for scheduling of the TXOP may be interpreted for each purpose. Additionally, the sharing AP may include an AID specifically allocated to the MU-RTS frame transmitted for TXOP scheduling to indicate the time required to exchange data with the non-AP STA associated with the sharing AP. Through ICF/ICR exchange, the sharing AP may identify the allocation duration required by the shared AP and the shared AP's DPS mode. Based on this information, the sharing AP may acquire a new TXOP and report the TXOP information to the shared AP.

The MU-RTS trigger frame transmitted by the sharing AP may include various fields such as the AID12 field indicating the AID of the shared AP, the RU allocation field indicating the RU for transmitting the CTS frame in response to the MU-RTS trigger frame, and the allocation duration field for indicating the time period of the TXOP.

Meanwhile, according to the proposed embodiment, the sharing AP may transmit information on the scheduling of the TXOP to the shared AP through the MU-RTS trigger frame, and then transmit the MU-RTS TXS trigger frame to notify the start (or initiation) of the C-TDMA (or TXS) within the corresponding TXOP. The MU-RTS TXS trigger frame may be a signaling/message for the sharing AP to trigger the TXOP of the shared AP by sharing the time resource of the TXOP with the shared AP. In this embodiment, the MU-RTS TXS trigger frame may notify the start (or initiation) of C-TDMA (or TXS) for multiple shared APs through multiple user info fields. In this case, the MU-RTS TXS trigger frame may distinguish each shared AP through an AID12 value included in the user info field. Furthermore, the sharing AP may implicitly indicate the order in which C-TDMA (or TXS) is performed within the TXOP through the order of the user info field included in the MU-RTS TXS trigger frame. Alternatively, the sharing AP may use some of the reserved bits in the MU-RTS TXS trigger frame as an explicit indicator for indicating the order in which C-TDMA (or TXS) is performed within the TXOP.

According to an embodiment, the sharing AP may indicate the length of the time period to be shared with the shared AP within the TXOP through the allocation duration field included in the MU-RTS TXS trigger frame. If the value indicated by the allocation duration field of the MU-RTS TXS trigger frame transmitted by the sharing AP is the same as the value indicated by the requested allocation duration field included in the ICR received from the shared AP, it may mean that the allocation duration requested by the shared AP through the ICR is approved. Meanwhile, if the value indicated by the allocation duration field of the MU-RTS TXS trigger frame transmitted by the sharing AP is less than the value indicated by the requested allocation duration field included in the ICR received from the shared AP, it may mean that the allocation duration requested by the shared AP through the ICR is not approved and an alternative allocation duration is allocated.

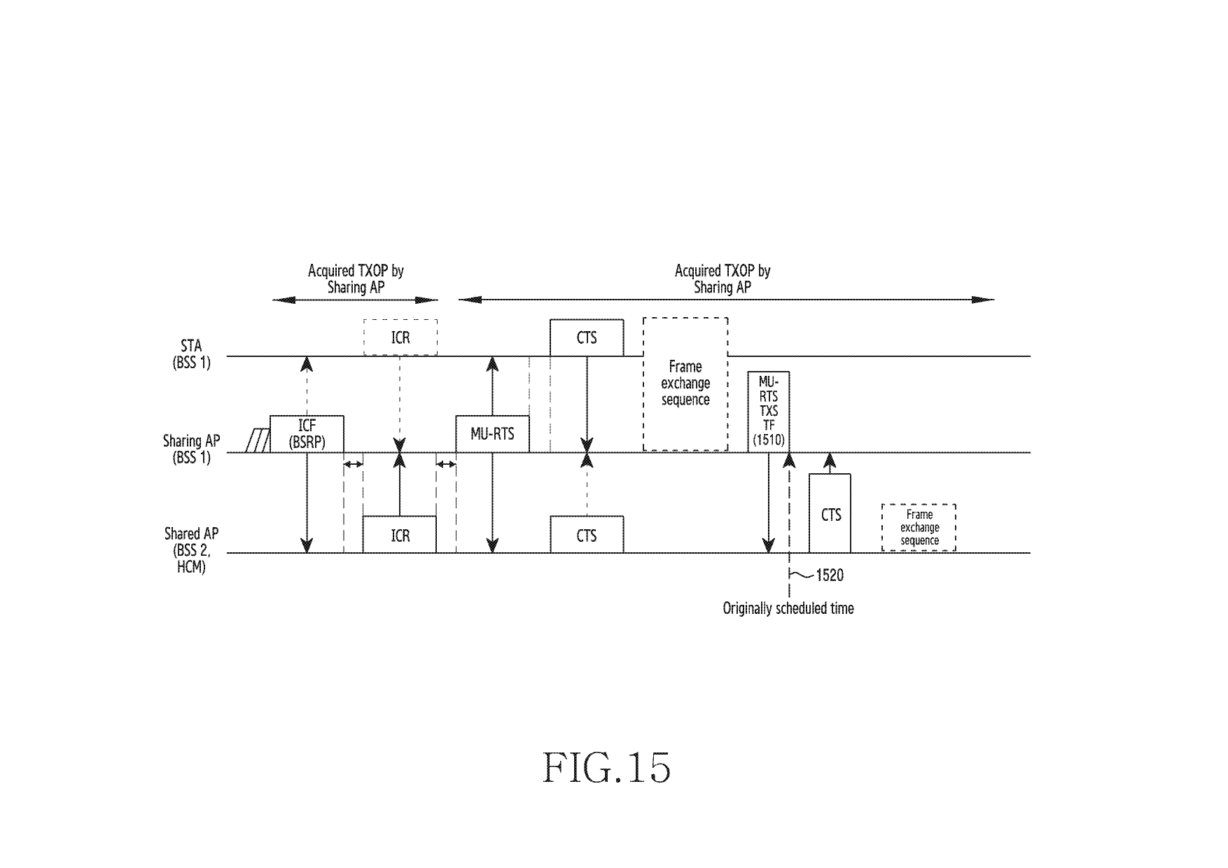

Meanwhile, the sharing AP may generate and transmit the MU-RTS TXTF according to the DPS mode received from the shared AP. Specifically, the sharing AP may determine the type of MU-RTS TXS trigger frame differently depending on the DPS mode transmitted by the shared AP through the ICR, and will be described in detail in FIGS. 15 to 18 below.

FIG. 15 is a diagram illustrating a C-TDMA (or TXS) operation considering DPS according to an embodiment of the disclosure. FIG. 15 describes a case in which a shared AP operates in HCM mode (or HCM state) in a TXOP.

Through the ICR received from the shared AP, the sharing AP may know in advance that the shared AP operates in HCM mode (or HCM state) in the TXOP. Accordingly, the sharing AP may transmit the MU-RTS trigger frame to announce the shared AP of information on the new TXOP, and then transmit a MU-RTS TXS trigger frame 1510 to notify the start (or initiation) of the C-TDMA (or TXS) in the TXOP.

According to an embodiment, the sharing AP may transmit a normal MU-RTS TXS trigger frame to the shared AP operating in the HCM mode. This is because the sharing AP operating in HCM mode (or HCM state) may normally receive and interpret the frame from the shared AP, so as the MU-RTS TXS trigger frame is received, the C-TDMA (or TXS) operation may be performed directly within the TXOP as the MU-RTS TXS trigger frame is received.

Therefore, the sharing AP may start (or initiate) C-TDMA (or TXS) that shares some of the time resources of the TXOP with the shared AP even if the sharing AP transmits the MU-RTS TXS trigger frame 1510 to the shared AP earlier than the time 1520 at which the shared AP originally decided to schedule.

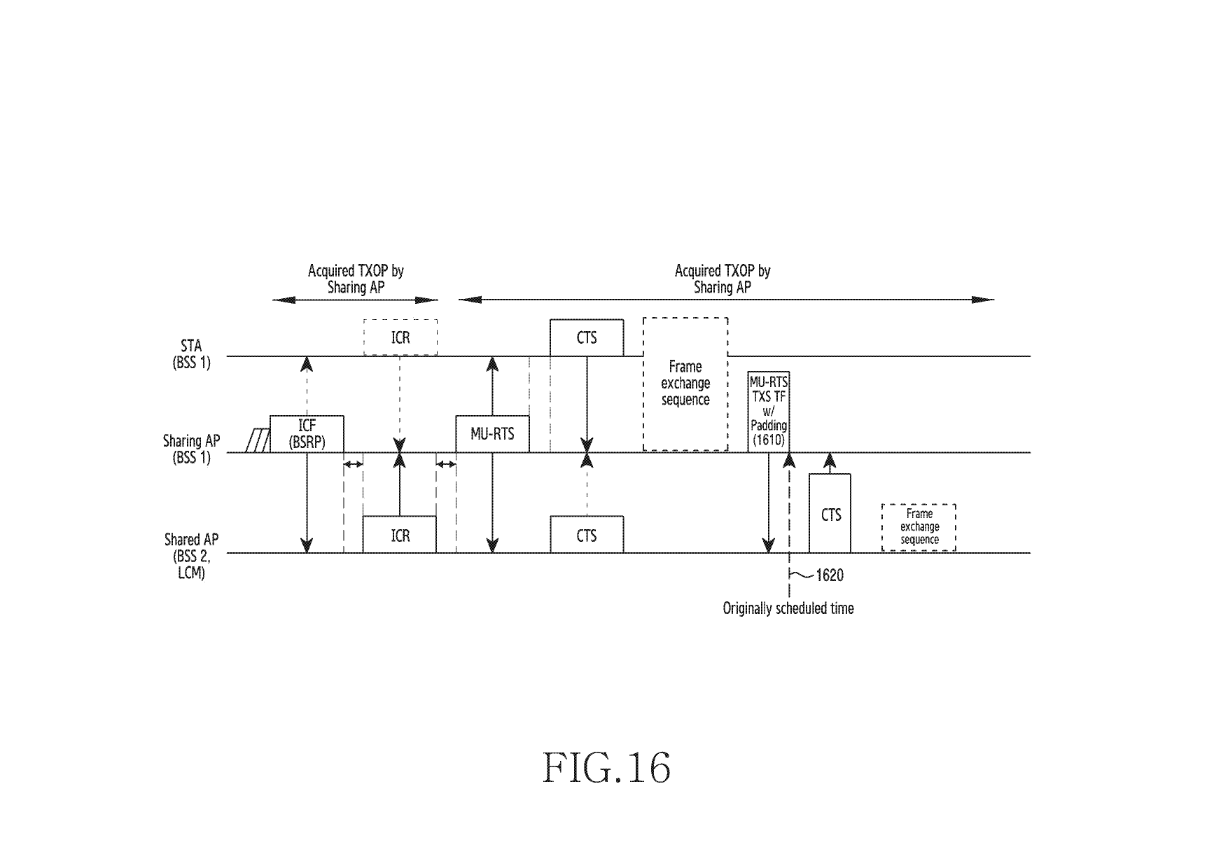

FIG. 16 is a diagram illustrating a C-TDMA (or TXS) operation considering DPS according to an embodiment of the disclosure. FIG. 16 describes a case in which a shared AP operates in LCM mode (or LCM state) in a TXOP.

Through the ICR received from the shared AP, the sharing AP may know in advance that the shared AP operates in LCM mode (or LCM state) in the TXOP. Accordingly, the sharing AP may transmit the MU-RTS trigger frame to announce the shared AP of information on the new TXOP, and then transmit an MU-RTS TXS trigger frame 1610 to notify the start (or initiation) of the C-TDMA (or TXS) in the TXOP.

According to an embodiment, the sharing AP may transmit a different MU-RTS TXS trigger frame other than a normal MU-RTS TXS trigger frame to the shared AP operating in the HCM mode. This is because the sharing AP operating in LCM mode (or LCM state) requires time to transition to DPS mode (or state) to properly receive frames from the shared AP.

Therefore, the sharing AP may transmit the MU-RTS TXS trigger frame 1610 that includes an intermediate (I)-FCS and padding, rather than a normal MU-RTS TXS trigger frame. The I-FCS and padding included in the MU-RTS TXS trigger frame 1610 according to the proposed embodiment may be inserted at a specific position among reserved bits included in the existing MU-RTS TXS trigger frame, inserted into a separately defined user info field or newly defined field, or added to the end of the existing MU-RTS TXS trigger frame. In addition, the MU-RTS TXS trigger frame of the proposed structure may include at least one of I-FCS or padding.

According to an embodiment, the shared AP receiving the MU-RTS TXS trigger frame including I-FCS and/or padding may secure the time required to transition from LCM mode (or LCM state) to HCM mode (or HCM state) as the time required for processing and interpreting the trigger frame in which I-FCS and/or padding are inserted increases. In other words, the sharing AP may control the shared AP to start (or initiate) C-TDMA (or TXS) in HCM mode (or HCM state) prior to the required scheduling time 1620 by transmitting the MU-RTS TXS trigger frame 1610 including I-FCS and/or padding to the shared AP earlier than the time 1620 when originally scheduling for the shared AP is required.

Meanwhile, the described embodiment may be applied to a situation in which the shared AP is expected to maintain the LCM mode (or LCM state) at the time when the shared AP starts (or initiates) C-TDMA (or TXS). In other words, if the shared AP in LCM mode (or LCM state) is expected to transition to HCM mode (or HCM state) when C-TDMA (or TXS) starts (or initiates), the sharing AP may transmit an existing MU-RTS TXS trigger frame rather than an MU-RTS TXS trigger frame including I-FCS and/or padding.

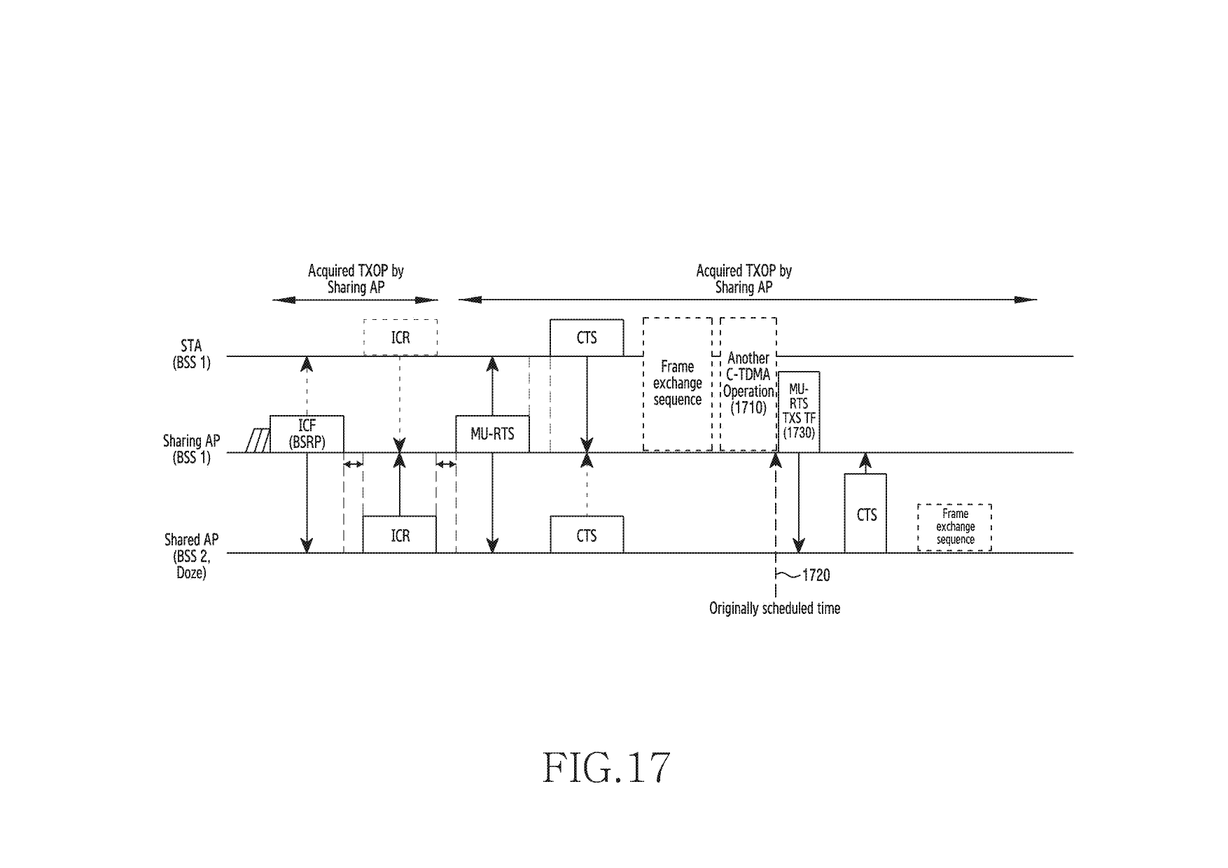

FIG. 17 is a diagram illustrating a C-TDMA (or TXS) operation considering DPS according to an embodiment of the disclosure. FIG. 17 describes a case in which a shared AP operates in doze mode (or doze state) in a TXOP.

Through the ICR received from the shared AP, the sharing AP may know in advance that the shared AP operates in doze mode (or doze state) in the TXOP. Accordingly, the sharing AP may perform C-TDMA (or TXS) for an AP other than the shared AP in the doze mode (or doze state) within the TXOP (1710). Since the shared AP is in doze mode (or doze state) at the time 1720 when scheduling was originally decided for the shared AP, the sharing AP may perform C-TDMA (or TXS) by allocating a portion of the TXOP to an AP other than the shared AP until that time 1720. If the shared AP transitions from doze mode (or doze state) to HCM mode (or HCM state), the sharing AP may terminate the C-TDMA (or TXS) operation for another AP and transmit the MU-RTS TXS trigger frame 1730 to the shared AP to perform C-TDMA (or TXS) for the shared AP.

According to another embodiment, instead of performing C-TDMA (or TXS) for an AP other than the shared AP, the sharing AP may provide a service to a non-AP STA of the BSS related to the sharing AP.

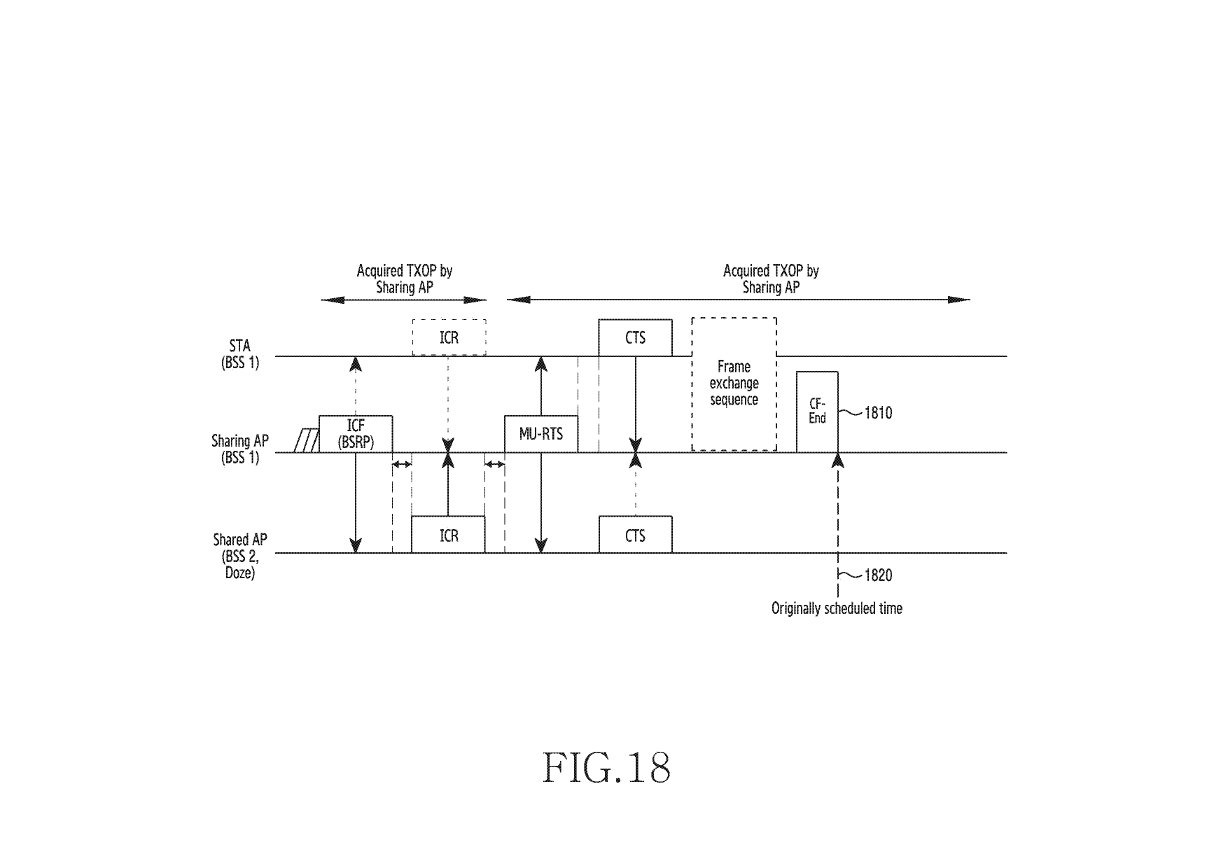

FIG. 18 is a diagram illustrating a C-TDMA (or TXS) operation considering DPS according to an embodiment of the disclosure. FIG. 18 describes a case in which a shared AP operates in doze mode (or doze state) in a TXOP.

Through the ICR received from the shared AP, the sharing AP may know in advance that the shared AP operates in doze mode (or doze state) in the TXOP. Accordingly, the sharing AP may determine that the service cannot be provided to the shared AP in the doze mode (or doze state) within the TXOP, transmit a CF-end frame 1810, and return the TXOP. Since the shared AP is in doze mode (or doze state) before the time 1820 when scheduling was originally decided for the shared AP, the sharing AP may determine that it is impossible to provide a normal service to the shared AP at the time 1820. Accordingly, the sharing AP may return the TXOP instead of performing C-TDMA (or TXS) with the shared AP.

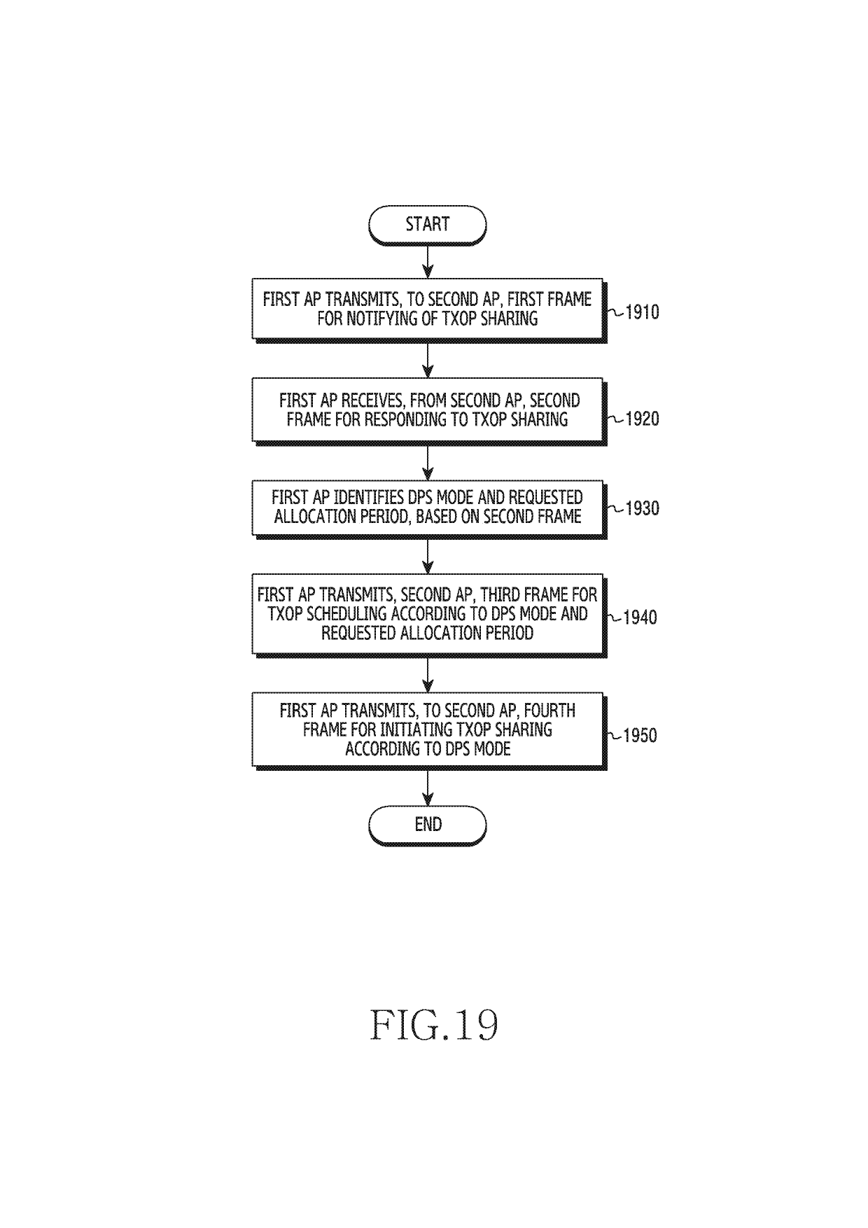

Hereinafter, operations of the sharing AP and the shared AP (or the polled AP) according to the above-described various embodiments will be described according to a time-series flow, respectively. In FIGS. 19, 20, and 21, the first AP may refer to the shared AP of the embodiments described above, and the second AP may refer to the shared AP (or polled AP) of the embodiments described above.

FIG. 19 illustrates a flowchart related to the operation of a first AP in a wireless LAN system according to an embodiment of the disclosure. In FIG. 19, some or all of the various embodiments described above for the process by which the first AP (i.e., the sharing AP) transmits and receives parameters and information related to DPS and C-TDMA may be applied identically or similarly to FIG. 19.

Referring to FIG. 19, the first AP transmits a first frame for notifying TXOP sharing to the second AP at operation 1910. The first frame transmitted by the first AP may be an ICF transmitted within the first AP's TXOP and, for example, the first frame may include a BSRP trigger frame. The first frame may be a frame to notify the first AP's intent for C-TDMA (or TXS).

The first AP receives a second frame from the second AP in response to the TXOP sharing request at operation 1920. The second frame received by the first AP may be an ICR in response to the ICF of the first AP and, for example, the second frame may include an M-BA frame. According to an embodiment, the second frame may indicate a result of the second AP's decision to participate in C-TDMA (or TXS), and may additionally indicate the DPS mode (or DPS state) of the second AP in the TXOP to which C-TDMA (or TXS) to be applied.

The first AP identifies the DPS mode and the requested allocation period from the received second frame at operation 1930. That is, based on the second frame received from the second AP, the first AP may identify in which DPS mode the second AP operates at the time when scheduling C-TDMA (or TXS) for a second AP within the TXOP and the allocation period requested by the second AP for C-TDMA (or TXS) within the TXOP, and may then determine to perform C-TDMA (or TXS) for the second AP within the TXOP.

The first AP transmits a third frame to the second AP for TXOP scheduling consider the DPS mode and allocation period at operation 1940. The third frame may be a frame transmitted from a TXOP separate from the TXOP in which the first frame and the second frame are exchanged and, for example, the third frame may include an MU-RTS trigger frame. The third frame may be a frame for notifying an allocation section of the TXOP acquired by the first AP.

The first AP transmits a fourth frame to start (or initiate) C-TDMA (or TXS) according to the DPS mode of the second AP at operation 1950. The fourth frame is a frame for notifying the start (or initiation) of C-TDMA (or TXS) in which the first AP shares a portion of the TXOP with the second AP and, for example, the fourth frame may include an MU-RTS TXS trigger frame.

Meanwhile, an example of the operation of the first AP (i.e., sharing AP) has been described above based on the flowchart illustrated in FIG. 19. However, it is obvious that the operation of the first AP (i.e., sharing AP) may vary according to other embodiments described above.

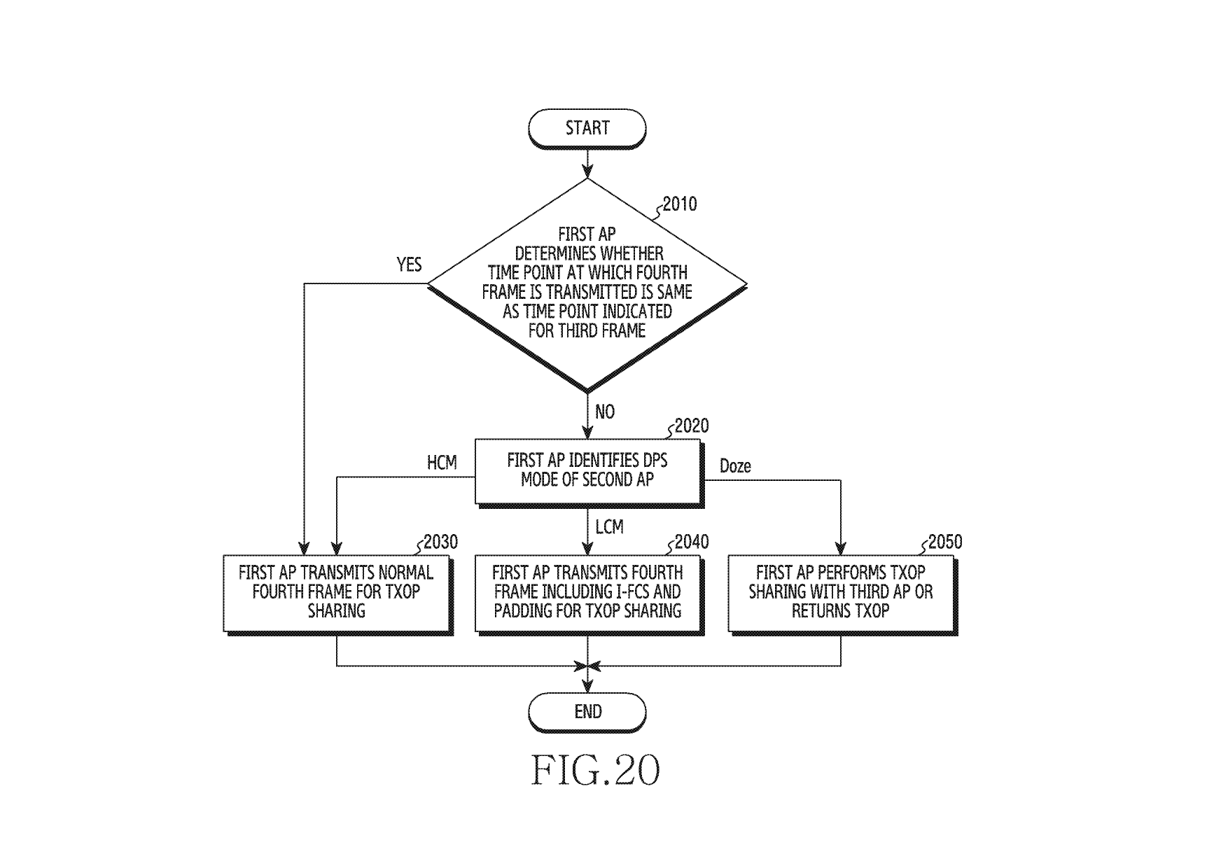

FIG. 20 illustrates a flowchart related to the operation of a first AP in a wireless LAN system according to an embodiment of the disclosure. In FIG. 20, some or all of the various embodiments described above for the process by which the first AP (i.e., the sharing AP) transmits and receives parameters and information related to DPS and C-TDMA may be applied identically or similarly to FIG. 20.

Referring to FIG. 20, the process of transmitting the fourth frame according to the DPS mode of the second AP by the first AP in operation 1950 of FIG. 19 will be described in more detail.

The first AP determines whether the time point at which the fourth frame is to be transmitted is the same as the time point indicated in an allocation period of the previously transmitted third frame at operation 2010. If the two time points are the same, the first AP determines that the second AP may perform C-TDMA (or TXS) at the corresponding time point within the TXOP and transmits a normal fourth frame for C-TDMA (or TXS) at operation 2030. If the two time points are different (e.g., the time point at which the first AP intends to transmit the fourth frame is earlier than the time point indicated through the third frame), the first AP identifies the DPS mode of the second AP from the second frame received from the second AP at operation 2020.

If the DPS mode of the second AP is HCM mode at the time when C-TDMA (or TXS) is performed within the TXOP (i.e., the time when the fourth frame is transmitted), the first AP may transmit the normal MU-RTS TXS trigger frame as the fourth frame at operation 2030. If the DPS mode of the second AP is LCM mode at the time when C-TDMA (or TXS) is performed within the TXOP (i.e., the time when the fourth frame is transmitted), the first AP may transmit an MU-RTS TXS trigger frame including at least one of I-FCS and padding as the fourth frame at operation 2040. If the DPS mode of the second AP is doze mode at the time when C-TDMA (or TXS) is performed within the TXOP (i.e., the time when the fourth frame is transmitted), the first AP may allocate a TXOP to another AP (e.g., a third AP) to perform C-TDMA (or TXS) with the third AP, or may return the TXOP instead of transmitting a fourth frame to the second AP to notify the start (or initiation) of C-TDMA (or TXS) at operation 2050.

Meanwhile, an example of the operation of the first AP (i.e., sharing AP) has been described above based on the flowchart illustrated in FIG. 20. However, it is obvious that the operation of the first AP (i.e., sharing AP) may vary according to other embodiments described above.

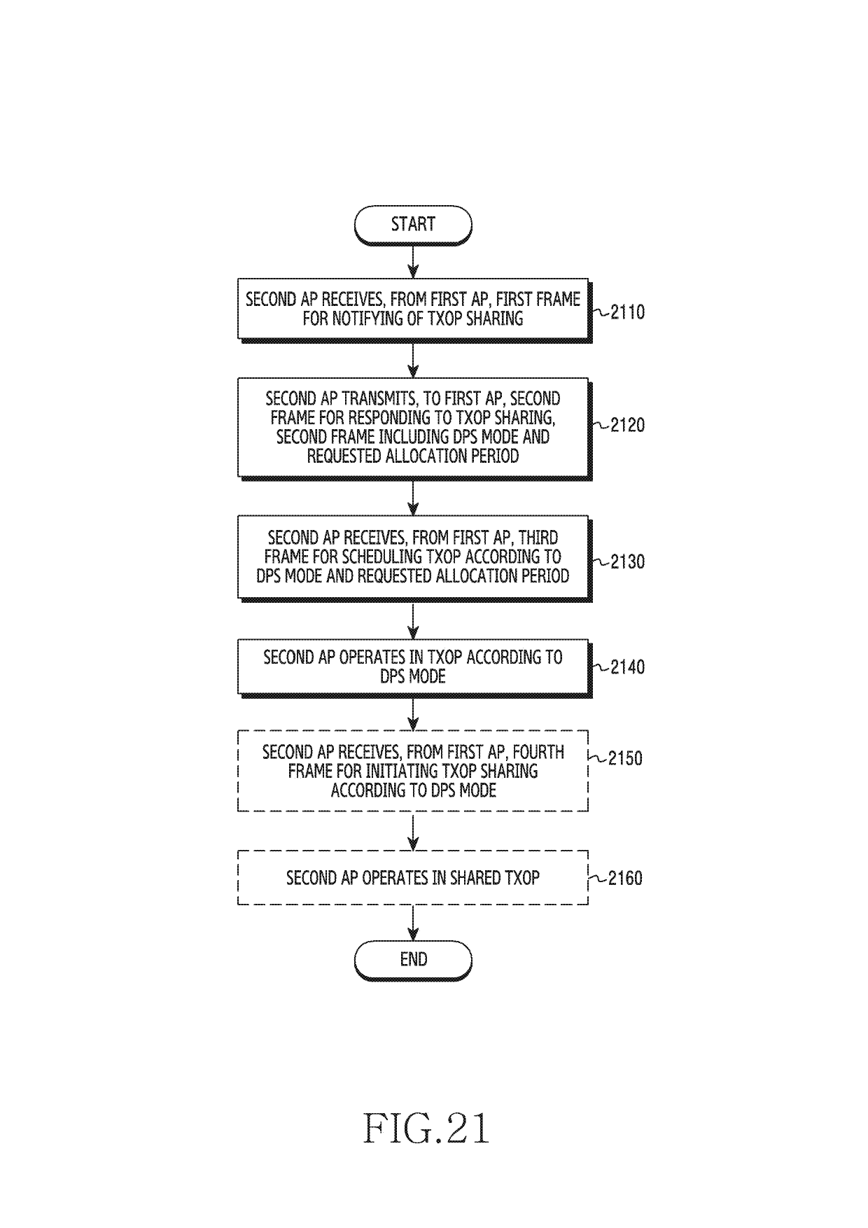

FIG. 21 illustrates a flowchart related to the operation of a second AP in a wireless LAN system according to an embodiment of the disclosure. In FIG. 21, some or all of the various embodiments described above for the process by which the second AP (i.e., the shared AP) transmits and receives parameters and information related to DPS and C-TDMA may be applied identically or similarly to FIG. 21.

Referring to FIG. 21, the second AP receives a first frame for notifying TXOP sharing from the first AP at operation 2110. The first frame received by the second AP may be an ICF received within the TXOP of the first AP and, for example, the first frame may include a BSRP trigger frame. The first frame may be a frame for notifying an intention of the first AP for C-TDMA (or TXS).

The second AP transmits a second frame for responding to the TXOP sharing to the first AP at operation 2120. The second frame transmitted by the second AP may be an ICR that is a response to the ICF of the first AP and, for example, the second frame may include an M-BA frame. According to an embodiment, the second frame may indicate a result of the second AP's decision to participate in C-TDMA (or TXS), and may additionally indicate the DPS mode (or DPS state) of the second AP in the TXOP to which C-TDMA (or TXS) to be applied.

The second AP receives from the first AP a third frame for scheduling a TXOP according to a DPS mode and an allocation period at operation 2130. The third frame may be a frame transmitted from a TXOP separate from the TXOP in which the first frame and the second frame are exchanged and, for example, the third frame may include an MU-RTS trigger frame. The third frame may be a frame for notifying an allocation period of the TXOP of the first AP, etc.

The second AP operates in the TXOP according to the DPS mode notified to the first AP at operation 2140, and the second AP receives a fourth frame from the first AP to start (or initiate) C-TDMA (or TXS) according to the DPS mode at operation 2150. The fourth frame is a frame for notifying the start (or initiation) of C-TDMA (or TXS) in which the first AP shares a portion of the TXOP with the second AP and, for example, the fourth frame may include an MU-RTS TXS trigger frame. Accordingly, the second AP may operate while performing frame exchange within the TXOP shared by the first AP at operation 2160.

According to an embodiment, if the DPS mode of the second AP is HCM mode at the time when C-TDMA (or TXS) is performed within the TXOP, the fourth frame may be a normal MU-RTS TXS trigger frame. If the DPS mode of the second AP is LCM mode at the time when C-TDMA (or TXS) is performed within the TXOP, the fourth frame may include an MU-RTS TXS trigger frame including at least one of I-FCS and padding. If the DPS mode of the second AP is doze mode at the time when C-TDMA (or TXS) is performed within the TXOP, the second AP may maintain the doze mode without receiving the fourth frame from the first AP, or may receive the fourth frame after transitioning from the doze mode to the HCM mode or the LCM mode.

Meanwhile, an example of the operation of the second AP (i.e., shared AP) has been described above based on the flowchart illustrated in FIG. 21. However, it is obvious that the operation of the second AP (i.e., shared AP) may vary according to other embodiments described above.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first access point (AP) in a wireless local area network (WLAN) system, the method comprising:
transmitting, to a second AP, a first frame for notifying of sharing of a transmission opportunity (TXOP);
receiving, from the second AP, a second frame for responding to the first frame, the second frame comprising information on a dynamic power save (DPS) mode related to the TXOP and information on a required TXOP length; and
transmitting, to the second AP, a third frame comprising information on a TXOP to be shared with the second AP.

2. The method of claim 1, further comprising:
in case that the DPS mode is a high capability mode (HCM), transmitting, to the second AP, a normal fourth frame for notifying of starting sharing of the TXOP; and
in case that the DPS mode is a low capability mode (LCM), transmitting, to the second AP, a fourth frame comprising at least one of an intermediate frame check sequence (I-FCS) or padding in order to notify of starting sharing of the TXOP.

3. The method of claim 2, further comprising, in case that the DPS mode is a doze mode, transmitting, to a third AP, a frame for notifying of starting sharing of the TXOP, or returning the TXOP.

4. The method of claim 2, wherein the first frame comprises a buffer status report poll (BSRP) trigger frame, the second frame comprises a multi-station block ack (M-BA) frame, the third frame comprises a multi-user request to send (MU-RTS) trigger frame, and the fourth frame comprises an MU-RTS transmission opportunity sharing (TXS) trigger frame.

5. The method of claim 1, wherein the third frame comprises scheduling information of the TXOP to be shared and an association identity (AID) for indicating a time required for data exchange with a station (STA) associated with the first AP.

6. A method performed by a second access point (AP) in a wireless local area network (WLAN) system, the method comprising:
receiving, from a first AP, a first frame for notifying of sharing of a transmission opportunity (TXOP);
transmitting, to the first AP, a second frame for responding to the first frame, the second frame comprising information on a dynamic power save (DPS) mode related to the TXOP and information on a requested TXOP length; and
receiving, from the first AP, a third frame comprising information on a TXOP to be shared with the second AP.

7. The method of claim 6, further comprising:
in case that the DPS mode is a high capability mode (HCM), receiving, from the first AP, a normal fourth frame for notifying of starting sharing of the TXOP; and
in case that the DPS mode is a low capability mode (LCM), receiving, from the first AP, a fourth frame comprising at least one of an intermediate frame check sequence (I-FCS) or padding in order to notify of starting sharing of the TXOP.

8. The method of claim 7, wherein, in case that the DPS mode is a doze mode, a frame for notifying of starting sharing of the TXOP is received after the doze mode ends.

9. The method of claim 7, wherein the first frame comprises a buffer status report poll (BSRP) trigger frame, the second frame comprises a multi-station block ack (M-BA) frame, the third frame comprises a multi-user request to send (MU-RTS) trigger frame, and the fourth frame comprises an MU-RTS transmission opportunity sharing (TXS) trigger frame.

10. The method of claim 6, wherein the third frame comprises scheduling information of the TXOP to be shared and an association identity (AID) for indicating a time required for data exchange with a station (STA) associated with the first AP.

11. A first access point (AP) in a wireless local area network (WLAN) system, the first AP comprising:
at least one transceiver;
at least one processor communicatively coupled to the at least one transceiver; and
at least one memory, communicatively coupled to the at least one processor, storing instructions executable by the at least one processor individually or in any combination to cause the first AP to:
transmit, to a second AP, a first frame for notifying of sharing of a transmission opportunity (TXOP),
receive, from the second AP, a second frame for responding to the first frame, the second frame comprising information on a dynamic power save (DPS) mode related to the TXOP and information on a requested TXOP length, and
transmit, to the second AP, a third frame comprising information on a TXOP to be shared with the second AP.

12. The first AP of claim 11, wherein the instructions further cause the first AP to:
in case that the DPS mode is a high capability mode (HCM), transmit, to the second AP, a normal fourth frame for notifying of starting sharing of the TXOP, and
in case that the DPS mode is a low capability mode (LCM), transmit, to the second AP, a fourth frame comprising at least one of an intermediate frame check sequence (I-FCS) or padding in order to notify of starting sharing of the TXOP.

13. The first AP of claim 12, wherein the instructions further cause the first AP to, in case that the DPS mode is a doze mode, transmit, to a third AP, a frame for notifying of starting sharing of the TXOP, or return the TXOP.

14. The first AP of claim 12, wherein the first frame comprises a buffer status report poll (BSRP) trigger frame, the second frame comprises a multi-station block ack (M-BA) frame, the third frame comprises a multi-user request to send (MU-RTS) trigger frame, and the fourth frame comprises an MU-RTS transmission opportunity sharing (TXS) trigger frame.

15. The first AP of claim 11, wherein the third frame comprise scheduling information of the TXOP to be shared and an association identity (AID) for indicating a time required for data exchange with a station (STA) associated with the first AP.

16. A second access point (AP) in a wireless local area network (WLAN) system, the second AP comprising:
at least one transceiver;
at least one processor communicatively coupled to the at least one transceiver; and
at least one memory, communicatively coupled to the at least one processor, storing instructions executable by the at least one processor individually or in any combination to cause the second AP to:
receive, from a first AP, a first frame for notifying of sharing of a transmission opportunity (TXOP),
transmit, to the first AP, a second frame for responding to the first frame, the second frame comprising information on a dynamic power save (DPS) mode related to the TXOP and information on a requested TXOP length, and
receive, from the first AP, a third frame comprising information on a TXOP to be shared with the second AP.

17. The second AP of claim 16, wherein the instructions further cause the second AP to:
in case that the DPS mode is a high capability mode (HCM), receive, from the first AP, a normal fourth frame for notifying of starting sharing of the TXOP, and
in case that the DPS mode is a low capability mode (LCM), receive, from the first AP, a fourth frame comprising at least one of an intermediate frame check sequence (I-FCS) or padding in order to notify of starting sharing of the TXOP.

18. The second AP of claim 17, wherein, in case that the DPS mode is a doze mode, a frame for notifying of starting sharing of the TXOP is received after the doze mode ends.

19. The second AP of claim 17, wherein the first frame comprises a buffer status report poll (BSRP) trigger frame, the second frame comprises a multi-station block ack (M-BA) frame, the third frame comprises a multi-user request to send (MU-RTS) trigger frame, and the fourth frame comprises an MU-RTS transmission opportunity sharing (TXS) trigger frame.

20. The second AP of claim 16, wherein the third frame comprises scheduling information of the TXOP to be shared and an association identity (AID) for indicating a time required for data exchange with a station (STA) associated with the first AP.
